(19) United States
(12) Patent Application Publication
(10) Pub. No.: US 2025/0006200 A1
(43) Pub. Date: Jan. 2, 2025

(54) INFORMATION PROCESSING DEVICE, INFORMATION PROCESSING METHOD, AND INFORMATION PROCESSING PROGRAM

(71) Applicant: SONY GROUP CORPORATION, TOKYO (JP)

(72) Inventors: MASATO NISHIO, TOKYO (JP); YUHEI YABE, TOKYO (JP)

(21) Appl. No.: 18/708,658

(22) PCT Filed: Oct. 24, 2022
(86) PCT No.: PCT/JP2022/039440

§ 371 Date: May 9, 2024

(30) Foreign Application Priority Data
Nov. 17, 2021 (JP) 2021-186795

(51) Int. Cl. G10L 17/10; G06V 20/59; G06V 40/16; G10L 17/02; G10L 25/57; G10L 25/63

(52) U.S. Cl. CPC G10L 17/10; G06V 20/59; G06V 40/171; G10L 17/02; G10L 25/57; G10L 25/63

(57) ABSTRACT

An information processing device (100) according to the present disclosure includes an acquisition unit (131) that acquires voices generated by a plurality of utterers and a video in which a state where the utterer generates an utterance is imaged, a specification unit (132) that specifies each of the plurality of utterers, on the basis of the acquired voice and video, a recognition unit (133) that recognizes an utterance generated by each specified utterer and an attribute of each utterer or a property of the utterance, and a generation unit (134) that generates a response to the recognized utterance, on the basis of the recognized attribute of each utterer or property of the utterance.

### FIELD

The present disclosure relates to an information processing device, an information processing method, and an information processing program that perform voice recognition and execute response processing to a recognized voice.

### BACKGROUND

In recent years, voice recognition by AI and utterance response processing for responding to an utterance of which the voice is recognized have been actively used. In such processing, a natural response to content of an utterance of a user and accurate voice recognition are required.

For example, a technology has been known for flexibly changing utterance content according to an interaction situation with the user, by holding an interaction scenario as data in advance (for example, Patent Literature 1). Furthermore, as a method for increasing accuracy of the voice recognition, a technology has been known for detecting a state of an utterer by reading movements of lips of the utterer or starting the voice recognition (for example, Patent Literatures 2 and 3).

### CITATION LIST

### Patent Literature

Patent Literature 1: JP 2004-109323 A
Patent Literature 2: JP 2019-125241 A
Patent Literature 3: JP 2019-128938 A

### SUMMARY

### Technical Problem

However, in a case where processing for returning a response along content is executed after performing voice recognition, there is a possibility that it is not possible to return an appropriate response only by improving recognizability. For example, in a case where AI searches for a destination or determines a destination on the basis of utterances of a plurality of persons who rides together, in an automobile, there is a possibility that voices are confused or it is not possible to understand an intention of the utterance.

Therefore, the present disclosure proposes an information processing device, an information processing method, and an information processing program that can improve accuracy of voice recognition and return an optimal response to the recognized voice.

### Solution to Problem

In order to solve the above problems, an information processing device according to one aspect of the present disclosure includes an acquisition unit that acquires voices generated by a plurality of utterers and a video in which a state where the utterer generates an utterance is imaged, a specification unit that specifies each of the plurality of utterers, on the basis of the acquired voice and video, a recognition unit that recognizes an utterance generated by each specified utterer and an attribute of each utterer or a property of the utterance, and a generation unit that generates a response to the recognized utterance, on the basis of the recognized attribute of each utterer or property of the utterance.

### BRIEF DESCRIPTION OF DRAWINGS

FIG. 1 is a cross-sectional view of a vehicle according to an embodiment.

FIG. 2 is a diagram illustrating an outline of information processing according to the embodiment.

FIG. 3 is a block diagram illustrating a flow of the information processing according to the embodiment.

FIG. 4 is a diagram illustrating a configuration example of the vehicle according to the embodiment.

FIG. 5 is a diagram illustrating an example of a user information storage unit according to the embodiment.

FIG. 6 is a diagram illustrating an example of an external status storage unit according to the embodiment.

FIG. 7 is a diagram illustrating an example of a determination model storage unit according to the embodiment.

FIG. 8 is a flowchart illustrating the flow of the information processing according to the embodiment.

FIG. 9 is a diagram illustrating a configuration example of an imaging device according to a modification.

FIG. 10 is a block diagram illustrating a configuration example of a schematic function of the vehicle control system

FIG. 11 is a diagram illustrating an example of a sensing region according to the embodiment.

FIG. 12 is a hardware configuration diagram illustrating an example of a computer that implements functions of an information processing device according to the present disclosure.

### DESCRIPTION OF EMBODIMENTS

Hereinafter, an embodiment of the present disclosure will be described in detail with reference to the drawings. Note that, in each embodiment below, the same component is denoted with the same reference numeral so as to omit redundant description.

The present disclosure will be described according to the following order of items.
1. Embodiment
1-1. Outline of Information Processing According to Present Disclosure
1-2. Configuration Example of Vehicle According to Embodiment
1-3. Procedure of Information Processing According to Embodiment
1-4. Modification According to Embodiment
2. Other Embodiments
2-1. Configuration of Imaging Device According to Modification
2-2. Configuration of Mobile Body
2-3. Others
3. Effects of Information Processing Device According to Present Disclosure
4. Hardware Configuration

### 1. Embodiment

### (1-1. Outline of Information Processing According to Present Disclosure)

Information processing according to the present disclosure specifies each utterer and recognizes each utterance in a case where a plurality of persons utters in a space, for example, an automobile or the like and generates a response to the recognized utterance.

For example, in a relatively noisy space such as an automobile, it tends to be difficult to accurately perform voice recognition. Furthermore, in a closed space such as an automobile, a plurality of persons often simultaneously uses the same voice agent (for example, car navigation system mounted on vehicle). In this case, since utterances of the plurality of persons are simultaneously recognized, there is a possibility that voice recognition accuracy of the voice agent is lowered.

Moreover, in a case where the voice recognition for each utterer is possible, it is difficult for the voice agent to determine what response is returned to that. For example, it is different for the voice agent to determine to respond to which question in a case where different questions are simultaneously received from the plurality of persons in the vehicle, and the voice agent returns an error (response such as “voice cannot be recognized”) as a result. In this way, particularly, there is a problem in that, in a situation where a plurality of persons is located in the closed space such as the automobile, it is difficult to perform accurate voice recognition.

An information processing device according the present disclosure solves the above problem, by executing processing to be described below. That is, the information processing device acquires each of voices generated by a plurality of utterers and a video in which a state where the utterer generates an utterance is imaged and specifies each of the plurality of utterers, on the basis of the acquired voice and video. Moreover, the information processing device recognizes each of the utterance generated by each specified utterer and an attribute of the utterer or a property of the utterance and generates a response to the recognized utterance, on the basis of the recognized attribute of each utterer or property of the utterance.

For example, by complementing utterance content using a lip-reading technology for reading movements of lips included in the video of the utterer and recognizing the utterance content, the information processing device improves the accuracy of the voice recognition, even in a case where it is difficult to perform voice recognition using only a voice under a noisy environment such as inside of an automobile. Furthermore, the information processing device determines a priority of a response to the utterance, by recognizing the attribute of the utterer (for example, order of plurality of persons) from the voice and the video of the utterer, and returns the response according to the priority. As a result, the information processing device can improve accuracy of the voice recognition and return an optimal response to the recognized voice.

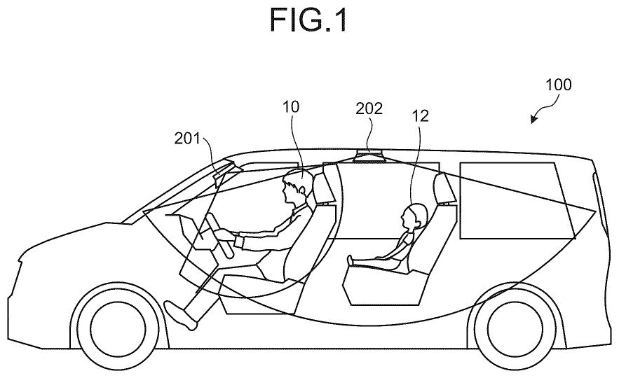

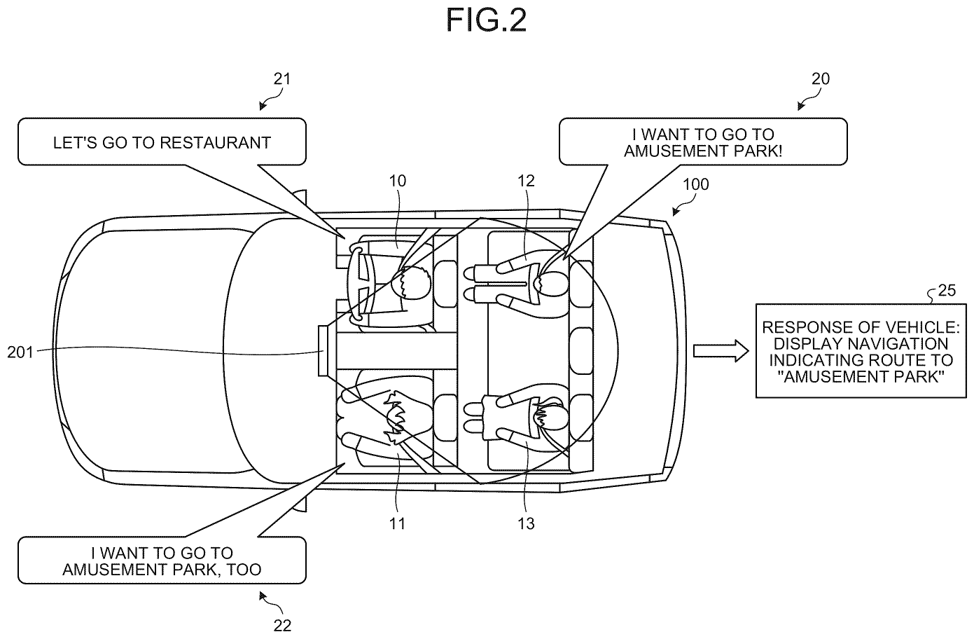

Hereinafter, information processing according to the present disclosure will be described in detail. First, an outline of information processing according to an embodiment of the present disclosure will be described with reference to FIGS. 1 and 2.

In the embodiment, as an information processing device according to the present disclosure, a vehicle 100 which is an automobile is taken as an example. FIG. 1 is a cross-sectional view of the vehicle 100 according to the embodiment. As illustrated in FIG. 1, on the vehicle 100, users 10 and 12 ride. Note that, although not illustrated in FIG. 1, other users 11 and 13 ride on the vehicle 100 (refer to FIG. 2).

In the embodiment, it is assumed that the users 10 to 13 be family members. For example, the user 10 is a father in the family, the user 11 is a mother, the user 12 is an older child, and the user 13 is a younger child. Hereinafter, in a case where it is not necessary to distinguish the members from each other, the users are simply referred to as a “user”.

The vehicle 100 has a function as the information processing device according to the present disclosure and executes the information processing according to the embodiment by operating various functional units to be described later. As illustrated in FIG. 1, the vehicle 100 includes cameras 201 and 202.

The cameras 201 and 202 are, for example, a stereo camera that can recognize a distance to an object to be imaged or a camera with a depth sensor including a time of flight (ToF) sensor. The cameras 201 and 202 are provided on a front side, a ceiling or a rear seat, or the like of the vehicle 100 so as to detect a person located in the vehicle 100 without a blind spot. Note that the cameras 201 and 202 are infrared cameras and may include a function of a thermo sensor (temperature detection). That is, the cameras 201 and 202 can recognize that a target imaged in the vehicle 100 is not a person displayed on a screen and is a living body that is actually located. Note that the cameras 201 and 202 may have various functions such as biological signal detection by millimeter waves, not limited to infrared rays. Furthermore, the vehicle 100 may detect a person or the like, by including an infrared sensor or the like, in addition to the cameras 201 and 202.

Furthermore, the vehicle 100 includes a microphone that can acquire a voice. The vehicle 100 recognizes a voice uttered by the user 10 or the like and generates various responses to the recognized voice. For example, when the user 10 utters a name of a destination, the vehicle 100 displays navigation display indicating a route to the destination on a display unit (liquid crystal display or the like) such as a front panel. That is, the vehicle 100 has a function as a voice agent (hereinafter, simply referred to as “agent”) that has a voice interaction function.

Furthermore, the vehicle 100 may include a sensor that detects a temperature or humidity inside and outside of the vehicle 100, a noise, future weather trends, increase prediction of an in-vehicle temperature, or the like. That is, the vehicle 100 can acquire various pieces of internal and external environmental information. Such environmental information is used for the information processing to be described later.

The vehicle 100 continuously acquires a voice and a video of the user 10 or the like in the vehicle 100 during traveling and achieves an agent function on the basis of the voice and the video. That is, in a case where the user 10 or the like requests a position of the destination or an arrival time, the vehicle 100 generates a response to the question and outputs a voice and a video related to the response. For example, the vehicle 100 notifies the user 10 of a time to the destination by a voice or displays a map to the destination.

Next, processing for generating responses to a plurality of persons by the vehicle 100 will be described with reference to FIG. 2. FIG. 2 is a diagram illustrating an outline of the information processing according to the embodiment.

In the example illustrated in FIG. 2, the vehicle 100 acquires an utterance 20 of “I want to go to the amusement park!” uttered by the user 12. After acquiring the utterance 20, the vehicle 100 acquires an utterance 21 of “Let's go to the restaurant” uttered by the user 10. After acquiring the utterance 21, the vehicle 100 acquires an utterance 22 of “I want to go to the amusement park, too” uttered by the user 11.

At this time, the vehicle 100 acquires a video captured by the camera 201, together with the voices of the utterances 20 to 22. Then, the vehicle 100 specifies a person who has generated each utterance, on the basis of the video of each utterer when each utterance is generated.

For example, the vehicle 100 specifies that a subject of the utterance 20 is the user 12 by recognizing that lips of the user 12 move when the voice of the utterance 20 is recognized. Alternatively, the vehicle 100 specifies that the subject of the utterance 20 is the user 12, on the basis of matching between content of the voice recognition of the utterance 20 and a result of lip reading based on movement of the lips of the user 12.

Alternatively, the vehicle 100 may specify that the subject of the voice of the utterance 20 is the user 12, by determining a person whose lips move when the voice of the utterance 20 is recognized, using an image recognition model learned in advance. Furthermore, the vehicle 100 may specify that the subject of the voice of the utterance 20 is the user 12, on the basis of a learning result indicating that a person on a right side of the rear seat is the user 12, on the basis of a video constantly captured by the camera 201. That is, the vehicle 100 specifies the person who is the subject of the utterance, by an arbitrary method. Specifically, the vehicle 100 specifies that the subject of the utterance 20 is the user 12, the subject of the utterance 21 is the user 10, and the subject of the utterance 22 is the user 11. Furthermore, the vehicle 100 recognizes that it has not been possible to acquire a voice uttered from the user 13 (not uttered).

When specifying the utterer, the vehicle 100 recognizes an attribute of each utterer. For example, the vehicle 100 recognizes an order between the utterers, on the basis of a rule setting an order of the specified utterers. In the example in FIG. 2, it is assumed that the vehicle 100 receive rule setting such that the plurality of persons located in the vehicle has an order of the user 11 (mother), the user 10 (father), the user 12 (older child), and the user 13 (younger child), in advance. Note that the rule does not necessarily include the above four users, and for example, may include a user who is a “unspecified person” in an order under the user 13 and may be, for example, a rule that defines only the order of the users 11 and 10. In the latter case, about the order of the users 12 and 13 not defined, the vehicle 100 may define the order by various methods, such as, placing a person estimated to be older in a higher order as a result of image recognition or placing a person with a larger number of responses generated on the basis of past learning results.

Furthermore, the vehicle 100 recognizes the voice uttered by each utterer and recognizes content and meaning of the utterance. For example, the vehicle 100 recognizes that the utterance 20 means that the user 12 wants to go to the amusement park. In this case, the vehicle 100 generates a response for starting a navigation indicating a route to the amusement park or providing information regarding a nearby amusement park, as a response to the utterance 20. Furthermore, the vehicle 100 recognizes that the utterance 21 means that the user 10 wants to go to the restaurant. In this case, the vehicle 100 generates a response for starting a navigation indicating a route to the restaurant or providing information regarding a nearby restaurant, as a response to the utterance 21. Furthermore, the vehicle 100 recognizes that the utterance 22 means that the user 11 wants to go to the amusement park. In this case, the vehicle 100 generates a response for starting a navigation indicating a route to the amusement park or providing information regarding a nearby amusement park, as a response to the utterance 22.

At this time, the vehicle 100 does not immediately generate the response based on each voice recognition and determines a priority of outputting the response, on the basis of the order. For example, the vehicle 100 preferentially outputs a response to the highest utterer, among the utterers.

That is, in the example in FIG. 2, the vehicle 100 preferentially generates and outputs the response to the utterance 22 of the user 11 who is the highest. Specifically, the vehicle 100 outputs a response 25 for displaying the navigation indicating the route to the “amusement park” or providing the information regarding the nearby amusement park.

Note that the vehicle 100 may generate a response for each recognized utterance, instead of generating a response after waiting for end of all the utterances. For example, the vehicle 100 recognizes the utterance 20 and generates the response to the utterance 20. Specifically, the vehicle 100 displays the navigation to the amusement park. Then, according to the utterance 21 of “Let's go to the restaurant” by the user 10, the vehicle 100 cancels the response to the utterance 20, on the basis of the order. That is, the vehicle 100 stops the response to the response to the utterance 20 and displays the navigation indicating the route to the restaurant or the like. Moreover, thereafter, according to the utterance 22 of “I want to go to the amusement park, too” by the user 11, the vehicle 100 cancels the response to the utterance 21, on the basis of the order. That is, the vehicle 100 stops the response to the utterance 21 and displays the navigation indicating the route to the amusement park or the like. In this way, the vehicle 100 may output the response after determining the priority of the response or may output the response according to the order, for example, by canceling the response after the output.

In this way, according to the vehicle 100 according to the embodiment, even in a case where the three users 10 to 12 almost simultaneously utter, each utterance content is accurately recognized by specifying each utterer. For example, by concurrently using lip reading, even under a situation where the plurality of voices is mixed, the vehicle 100 recognizes the utterance content for each utterer. Moreover, the vehicle 100 can generate a response more suitable for the situation, by using the attribute of the utterer (order in example in FIG. 2). That is, the vehicle 100 can improve the accuracy of the voice recognition and return the optimal response to the recognized voice.

Note that the vehicle 100 may generate the response or determine the priority of the response, according to not only the attribute of the utterer but also the property of the utterance, an external environment, or the like. The property of the utterance includes, for example, composition information (sound pressure, pitch, and difference from utterance of normal utterer) of the uttered voice, an emotion of the utterer analyzed from the composition information of the voice or the like.

For example, even if the utterance is an utterance generated by a user with a low order, in a case of recognizing that the utterance has a sense of urgency or tightness from the sound pressure of the utterance or a difference from a voice normally generated by that person, the vehicle 100 determines that a priority of a response to the utterance is high. Specifically, in a case where the user 10 says “Be careful!” with a loud voice and warns a person in the vehicle 100, even if another person is uttering, the vehicle 100 generates a response to the utterance of the user 10, such as stopping music played in the vehicle 100 or issuing a predetermined warning, instead of generating a response to the utterance of the user 10.

Furthermore, the vehicle 100 may determine whether or not the utterance is directed to the agent, as the property of the utterance and determine a priority of generation according to the determination result. For example, in a case where the user 10 makes an utterance toward the rear seat, it is assumed that the utterance be generated toward the users 12 and 13, not the agent. The vehicle 100 can determine that the utterance is not generated toward the agent from the video in which the user 10 is imaged and can decide not to generate the response to the utterance or can lower the priority. Note that the vehicle 100 may determine whether or not the utterance is generated toward the agent, on the basis of a direction of a line of sight or a face of the user, directivity of the voice, content of the utterance, or the like.

Furthermore, the vehicle 100 may generate the response according to the external environment. For example, it is assumed that the vehicle 100 detect an approach of an emergency vehicle, as an example of the external environment. In this case, even if an utterance is generated in the vehicle, the vehicle 100 generates a response for issuing a predetermined warning such as “Please stop the vehicle” or stopping music played in the vehicle, in preference to a response to the utterance. Alternatively, in a case where an utterance to increase a volume of the music in the vehicle is generated despite a midnight time, the vehicle 100 may generate a response for issuing a predetermined warning such as “This will annoy others”, in preference to a response to the utterance. Furthermore, in a case where an utterance to go to a region where driving is difficult is generated although the weather is getting worse, the vehicle 100 may generate a response for issuing a predetermined warning such as “It is dangerous to go there”, in preference to a response to the utterance.

As described above, the vehicle 100 optimizes the response by generating various responses on the basis of the utterance of each utterer, the attribute of each utterer, the property of the utterer, the external environment, or the like.

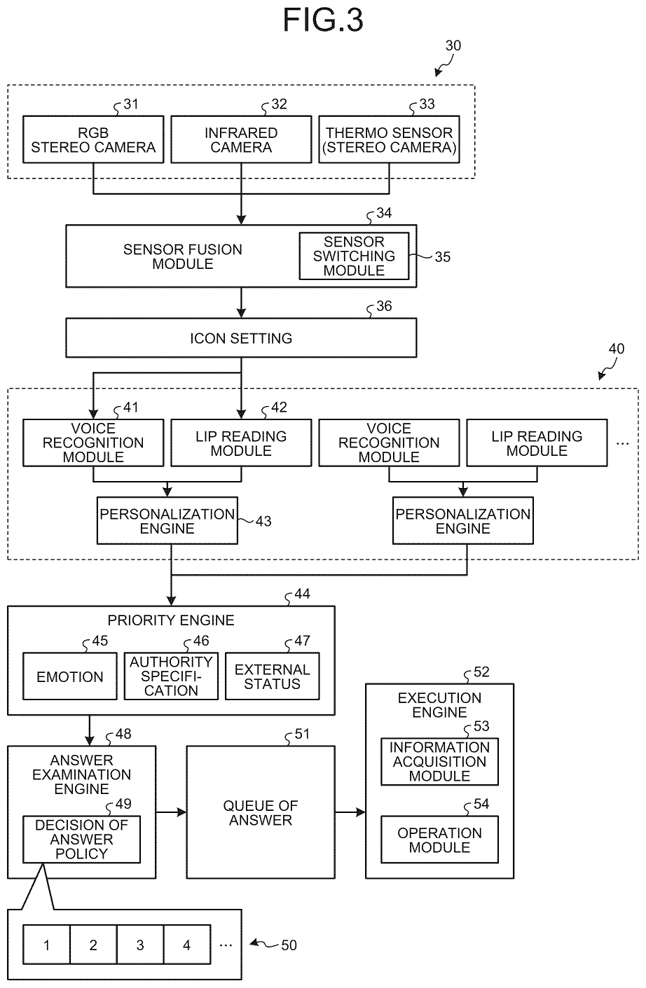

The information processing will be described in more detail while indicating a flow of the processing with reference to FIG. 3. FIG. 3 is a block diagram illustrating the flow of the information processing according to the embodiment. In FIG. 3, an example of a configuration regarding the information processing and the flow of the information processing in the configuration are illustrated as a conceptual block diagram. Note that each block illustrated in FIG. 3 conceptually illustrates each mechanism or each function merely as description, and various modifications may be made.

As illustrated in FIG. 3, the vehicle 100 includes an imaging device 30. The imaging device 30 includes an RGB stereo camera 31, an infrared camera 32, and a thermo sensor 33. Note that the thermo sensor 33 may be incorporated in the RGB stereo camera 31 or the like. For example, the vehicle 100 may detect an illuminance with the RGB stereo camera 31, capture a person with the RGB stereo camera 31 if the illuminance is equal to or more than a predetermined value, and capture the person with the infrared camera 32 if the illuminance is equal to or less than the predetermined value (night time or the like). Furthermore, the vehicle 100 determines whether or not a person is actually located with the thermo sensor 33 or the like.

Data captured by the imaging device 30 is sent to a sensor fusion module 34 and processed. For example, the sensor fusion module 34 determines a location of a person or recognizes a person, on the basis of the videos captured by the RGB stereo camera 31 and the infrared camera 32. Furthermore, the sensor fusion module 34 complements information indicating whether or not the person is located, with information detected by the thermo sensor 33. Note that a sensor switching module 35 is a functional unit that switches the imaging device 30 for imaging the person according to the environmental information such as the illuminance or selects the imaging device 30 according to a situation.

Furthermore, the vehicle 100 may perform icon setting 36 regarding the agent. The icon setting 36 is processing for displaying an icon indicating the agent on a liquid crystal display or the like. For example, a personalization engine 43 to be described later uses whether or not the utterer is speaking toward the icon indicating the agent or the like, as a determination element.

In the vehicle 100, a recognizer 40 performs personalization recognition on the voice of the utterer or who is the utterer. The recognizer 40 includes a voice recognition module 41, a lip reading module 42, and the personalization engine 43.

The voice recognition module 41 acquires a voice, recognizes the acquired voice, and analysis intention of the utterance or the like. The lip reading module 42 recognizes the voice generated by the utterer and analyzes the intention of the utterance or the like, using a lip reading technology. The lip reading module 42 complements processing of the voice recognition module 41, for example, under a situation in which it is difficult for the voice recognition module 41 to acquire the voice (noise or the like).

The personalization engine 43 recognizes who is the utterer, on the basis of the voice acquired by the voice recognition module 41 and the video acquired by the sensor fusion module 34. Note that, as illustrated in FIG. 3, the voice recognition module 41, the lip reading module 42, and the personalization engine 43 are parallelized, and can simultaneously recognize a plurality of persons.

Information that has passed through the recognizer 40 is input into a priority engine 44. The priority engine 44 determines a priority of generation of a response (for example, answer to utterance). For example, the priority engine 44 uses an emotion 45, authority specification 46, and an external status 47, as the determination element. The emotion 45 is information indicating a sense of urgency of the user, analyzed from the property of the utterance, the composition information of the voice, or the like. The authority specification 46 is, for example, an order between users defined on a rule basis or the like. The external status 47 is the external environment such as a time band or weather, an external situation such as approach of an emergency vehicle, or the like.

Information that has passed through the priority engine 44 is input into an answer examination engine 48. The answer examination engine 48 determines a decision 49 of an answer policy, according to the priority. For example, in the decision 49 of the answer policy, the priority and the generated answer are arranged in a form as a matrix 50.

The answer examination engine 48 sets the matrix 50 formed according to the decision 49 of the answer policy as a queue 51 of the answer and transfers the queue 51 to an execution engine 52. The execution engine 52 acquires the queue 51 with an information acquisition module 53. An operation module 54 performs an actual operation, in accordance with an order of the queue 51. For example, the operation module 54 performs a specific operation regarding an answer set in the queue 51, such as navigation display according to answer utterance.

### (1-2. Configuration Example of Vehicle According to Embodiment)

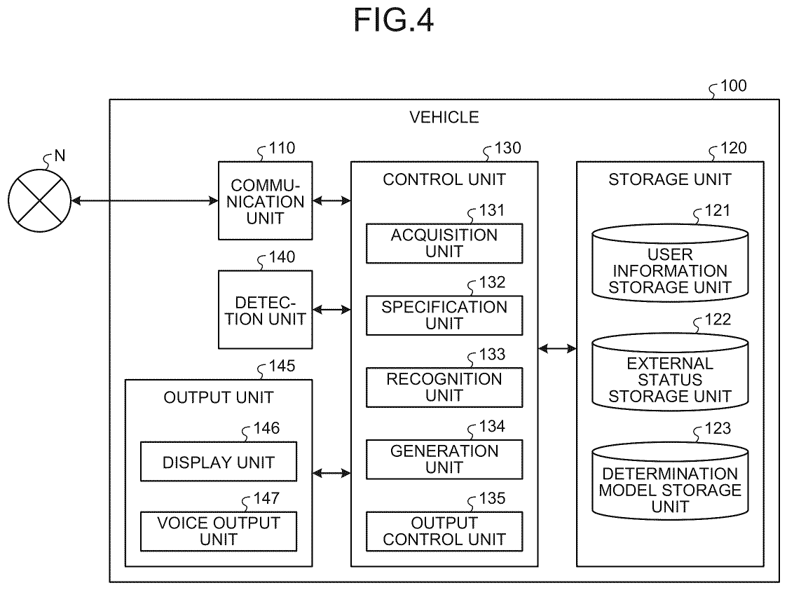

Next, a configuration of the vehicle 100 will be described with reference to FIG. 4. FIG. 4 is a diagram illustrating a configuration example of the vehicle 100 according to the embodiment of the present disclosure. As illustrated in FIG. 4, the vehicle 100 includes a communication unit 110, a storage unit 120, a control unit 130, a detection unit 140, and an output unit 145. Note that the configuration illustrated in FIG. 4 is a functional configuration, and a hardware configuration may be different from this. Furthermore, functions of the vehicle 100 may be distributed and mounted in a plurality of devices physically separated.

The communication unit 110 is implemented, for example, by a network interface controller, a network interface card (NIC), or the like. The communication unit 110 may be a USB interface including a universal serial bus (USB) host controller, a USB port, or the like. Furthermore, the communication unit 110 may be a wired interface or a wireless interface. For example, the communication unit 110 may be a wireless communication interface of a wireless LAN system or a cellular communication system. The communication unit 110 functions as communication means or transmission means of the vehicle 100. For example, the communication unit 110 is wiredly or wirelessly connected to a network N, and transmits and receives information with an external device such as a cloud server, other information processing terminals, or the like, via the network N. The network N is a generic name of the network connected to the vehicle 100 and is, for example, the Internet, a mobile phone communication network, or the like.

The storage unit 120 is implemented, for example, by a semiconductor memory element such as a random access memory (RAM) or a flash memory, or a storage device such as a hard disk or an optical disk. The storage unit 120 stores various type of data. For example, the storage unit 120 stores a learning device (determination model) that has learned a detection target, data regarding the detected person, or the like. Note that the storage unit 120 may store map data used to perform the navigation or the like. In the example in FIG. 4, the storage unit 120 includes a user information storage unit 121, an external status storage unit 122, and a determination model storage unit 123.

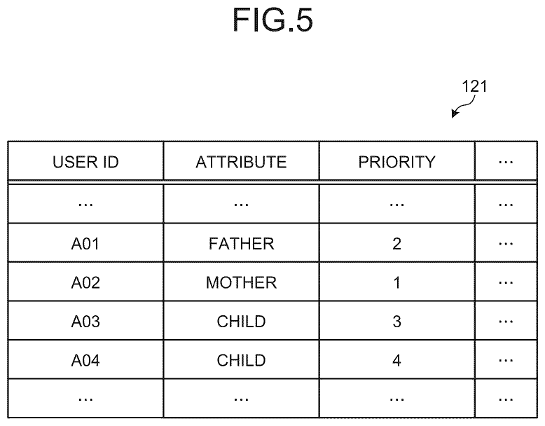

FIG. 5 is a diagram illustrating an example of the user information storage unit 121 according to the embodiment. As illustrated in FIG. 5, the user information storage unit 121 includes items such as a “user ID”, an “attribute”, and a “priority”.

The “user ID” is identification information used to identify a user of the vehicle 100. The “attribute” indicates an attribute of each user. In the example in FIG. 5, an attribute in a family of the user 10 who is a family member or the like is exemplified as an example. The “priority” indicates a priority (order) associated with the user.

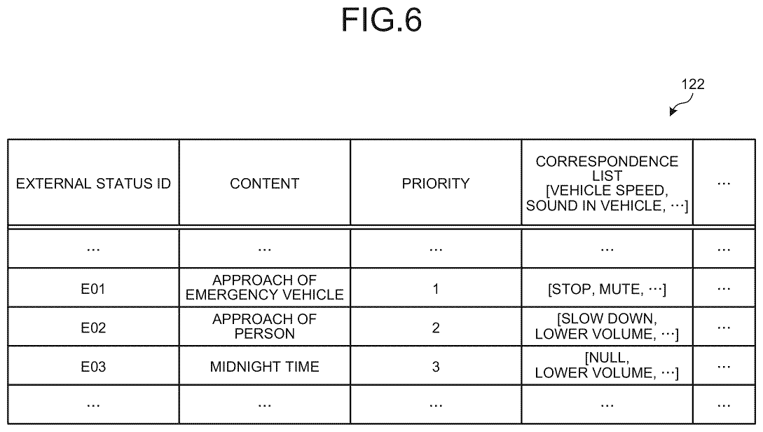

Next, the external status storage unit 122 will be described with reference to FIG. 6. FIG. 6 is a diagram illustrating an example of the external status storage unit 122 according to the embodiment. As illustrated in FIG. 6, the external status storage unit 122 includes items such as an “external status ID”, “content”, a “priority”, and a “correspondence list”.

The “external status ID” is identification information used to identify an external status including the external environment, the external situation, or the like, used to generate the response by the vehicle 100. The “content” indicates content of the external status. The “priority” indicates a priority of generating a response regarding the external status. The “correspondence list” indicates specific content of the response performed by the vehicle 100, in a case where the situation of the external status is confirmed. For example, a correspondence list with a configuration of (vehicle speed, sound in vehicle) and to which content (stop, mute) is set indicates that the vehicle 100 is stopped and music played in the vehicle 100 or the like is stopped, as the response of the vehicle 100, in a case where the content of the external status occurs.

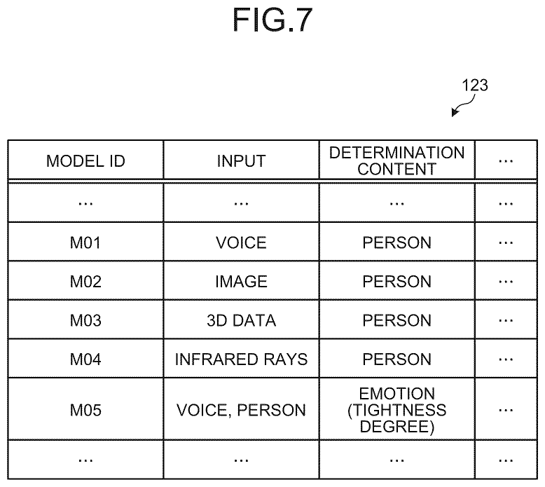

Next, the determination model storage unit 123 will be described with reference to FIG. 7. FIG. 7 is a diagram illustrating an example of the determination model storage unit 123 according to the embodiment. As illustrated in FIG. 7, the determination model storage unit 123 includes items such as a “model ID”, an “input”, and “determination content”.

The “model ID” indicates identification information used to identify a determination model used for the information processing. The “input” indicates a type of information to be input into the determination model. The “determination content” indicates determination content output from the determination model.

For example, in the example in FIG. 7, it is indicated that a determination model identified by a model ID “M01” is a model that outputs a “person” as a determination result, in a case where a “voice” is input. That is, the determination model identified by the model ID “M01” is a learned model that has learned a voice of the user who uses the vehicle 100 and is a model that outputs information used to specify the user (for example, score indicating possibility that voice is voice of user 10), in a case where the voice of the user is input. Note that the determination model may be created by any learning method. Furthermore, the vehicle 100 does not necessarily hold the determination model in the own device and may appropriately acquire a model that can execute determination processing necessary for the information processing from an external device or the like (for example, cloud server for executing learning processing or the like).

Returning to FIG. 4, the description will be continued. The detection unit 140 detects various types of information regarding the vehicle 100. Specifically, the detection unit 140 detects an environment around the vehicle 100, position information where the vehicle 100 is located, information regarding a device connected to the vehicle 100, or the like. The detection unit 140 may be read as a sensor that detects various types of information.

For example, an example of the detection unit 140 is a sensor that has a function for imaging surroundings of the vehicle 100, that is, a so-called camera. In this case, the detection unit 140 corresponds to the cameras 201 and 202 illustrated in FIG. 1, the imaging device 30 illustrated in FIG. 3, or the like.

Furthermore, the detection unit 140 may include a sensor that measures a distance to an object in or around the vehicle 100. For example, the detection unit 140 may be a light detection and ranging (LiDAR) that reads a three-dimensional structure of a surrounding environment of the vehicle 100. The LIDAR detects a distance to an object or a relative speed, by irradiating the surrounding object with a laser light beam such as an infrared laser and measuring a time until the laser beam is reflected and returned. Furthermore, the detection unit 140 may be a distance measuring system using a millimeter wave radar. Furthermore, the detection unit 140 may include a depth sensor used to acquire depth data.

Furthermore, the detection unit 140 may include a sensor used to measure travel information, the environmental information, or the like of the vehicle 100. For example, the detection unit 140 detects a behavior of the vehicle 100. For example, the detection unit 140 is an acceleration sensor that detects an acceleration of a vehicle, a gyro sensor that detects a behavior, an inertial measurement unit (IMU), or the like.

Furthermore, the detection unit 140 may include a microphone that collects sounds inside and outside the vehicle 100, an illuminance sensor that detects an illuminance around the vehicle 100, a humidity sensor that detects a humidity around the vehicle 100, a geomagnetic sensor that detects a magnetic field at a location position of the vehicle 100, or the like.

The output unit 145 is a mechanism that outputs various types of information. For example, the output unit 145 includes a display unit 146 that displays a video and a voice output unit 147 that outputs a voice. The display unit 146 is, for example, a liquid crystal display or the like. For example, the display unit 146 displays an image captured by the detection unit 140 or displays a response generated for the utterance of the user, such as a navigation display. Furthermore, the display unit 146 may also serve as a processing unit that receives various operations from the user who uses the vehicle 100 or the like. For example, the display unit 146 may receive input of various types of information, via a key operation, a touch panel, or the like. Furthermore, the voice output unit 147 is a so-called speaker and outputs various voices. For example, the voice output unit 147 outputs a voice of the voice agent mounted on the vehicle 100 and various responses generated by a generation unit 134 to be described later, as a voice. Note that the output unit 145 may include a light output unit that notifies various types of information by blinking light such as an LED, a projector that projects a video, or the like, without limiting to the display unit 146 and the voice output unit 147.

The control unit 130 is implemented by executing a program (for example, information processing program according to the present disclosure) stored in the vehicle 100, for example, by a central processing unit (CPU), a micro processing unit (MPU), or the like using a random access memory (RAM) or the like as a work area. Furthermore, the control unit 130 is a controller (controller), and for example, may be implemented by an integrated circuit such as an application specific integrated circuit (ASIC) or a field programmable gate array (FPGA).

As illustrated in FIG. 4, the control unit 130 includes an acquisition unit 131, a specification unit 132, a recognition unit 133, and the generation unit 134 and implements and executes functions and actions of the information processing to be described below. Note that an internal configuration of the control unit 130 is not limited to the configuration illustrated in FIG. 4, and may be another configuration as long as the configuration executes the information processing to be described later.

The acquisition unit 131 acquires various types of information. For example, the acquisition unit 131 acquires each of voices generated by a plurality of utterers and a video in which a state where the utterer generates an utterance is imaged, via the detection unit 140. Specifically, the acquisition unit 131 acquires a video captured by the imaging device 30 installed in the vehicle 100 on which the plurality of utterers rides.

The acquisition unit 131 acquires a video in which lips of the utterer are imaged, as a video. As a result, a processing unit at a subsequent stage can recognize the voice by lip reading or specify the utterer.

Note that the acquisition unit 131 may acquire the video in which the state where the utterer generates the utterance is imaged, after detecting the utterer through temperature detection by the detection unit 140. As a result, the acquisition unit 131 can acquire a video of a person who is actually located in a space, not a person imaged in a television video or the like.

Furthermore, the acquisition unit 131 may acquire the number and positions of persons located in the vehicle 100, a situation of the person in the vehicle 100, or the like, on the basis of the video. Specifically, the acquisition unit 131 acquires information regarding positions where the plurality of utterers is located, in a space where the plurality of utterers is located. As a result, even in a case where it is not possible to clearly recognize a person in a video or the like, the processing unit at the subsequent stage can normally estimate that the persons sitting on the rear seats are the users 12 and 13.

Furthermore, the acquisition unit 131 may acquire the composition information of the voice generated by each of the plurality of utterers. That is, the acquisition unit 131 acquires a sound pressure and a pitch of the voice, a difference from an utterance voice at the normal time, or the like. For example, the acquisition unit 131 may determine the difference between the utterance voice at the normal time and a voice to be processed, using a determination model that has learned the voice of the user.

Furthermore, the acquisition unit 131 may acquire information regarding an environment of the space where the plurality of utterers is located. For example, the acquisition unit 131 acquires the environmental information in the vehicle such as the temperature or the humidity in the vehicle 100. Furthermore, the acquisition unit 131 acquires the environmental information outside the vehicle such as an external temperature outside the vehicle 100, temperature increase prediction, or the like. Furthermore, the acquisition unit 131 may acquire information regarding weather outside the vehicle, a time band, future weather, of the like from an external service server (server for providing weather service or the like).

Furthermore, the acquisition unit 131 may acquire information indicating whether or not a predetermined situation defined in advance occurs, as the information regarding the external environment. For example, the acquisition unit 131 may acquire information regarding a situation where the emergency vehicle is approaching or a situation where an emergency (disaster or the like) occurs, as the detection result of the external environment.

The specification unit 132 specifies each of the plurality of utterers, on the basis of the voice and the video acquired by the acquisition unit 131.

For example, the specification unit 132 specifies each of the plurality of utterers, on the basis of the video in which the lips of the utterer are imaged. For example, the specification unit 132 specifies that the user whose lips move when the voice is generated, as the utterer of the voice. Alternatively, the specification unit 132 specifies each of the plurality of utterers, on the basis of collation between results of the voice recognition and the lip reading.

The recognition unit 133 recognizes each of the utterance generated by the utterer specified by the specification unit 132, the attribute of each utterer, or the property of the utterance.

For example, the recognition unit 133 recognizes each utterance generated by each utterer, on the basis of the voice generated by each utterer or the movement of the lips of each utterer. That is, the recognition unit 133 recognizes each of the content and the intention of the utterance generated by each utterer, using one or both of the recognition by the voice and the recognition by the lip reading.

Furthermore, the recognition unit 133 may recognize the attributes of the plurality of utterers, on the basis of the information regarding the positions where the plurality of utterers is located, in the vehicle 100. That is, the recognition unit 133 recognizes a user who sits on a front seat or a user who sits on a rear seat in advance, on the basis of a video in which the inside of the vehicle 100 is constantly imaged, and recognizes an attribute of the user, on the basis of the position of the user who sits on the seat in a case where a voice is generated.

Furthermore, the recognition unit 133 may recognize the attributes of the plurality of utterers, on the basis of the composition information of each of the voices generated by the plurality of utterers. That is, the recognition unit 133 constantly acquires the voice generated in the vehicle 100, learns its feature, and generates the determination model. Then, in a case where the voice is input, the recognition unit 133 recognizes the utterer who has generated the voice and the attribute of the utterer, on the basis of a feature amount such as a sound pressure or a waveform of the voice. In this case, the recognition unit 133 can more accurately recognize the attribute of the utterer, by referring to the information of the user information storage unit 121 or the like in which the rule for defining the attribute in advance is held, together with the determination model.

Furthermore, the recognition unit 133 may recognize whether or not the plurality of utterers requests to generation of the response, on the basis of the acquired voice and video. That is, the recognition unit 133 recognizes whether or not the utterance is made to the agent or the utterance is merely a conversation between the users, on the basis of the video and the voice.

For example, the recognition unit 133 recognizes whether or not the plurality of utterers requests the generation of the response, on the basis of the line of sight or the direction of the lips of the utterer in the acquired video. As an example, the recognition unit 133 may recognize whether or not the user requests the generation of the response, using whether or not the voice is generated toward the icon (display of microphone or the like) of the agent or whether or not the line of sight of the user is directed to the icon, as the determination element.

Furthermore, the recognition unit 133 may recognize whether or not the plurality of utterers requests the generation of the response, on the basis of at least one of the content of the voice generated by the utterer, the directivity of the voice, and the composition information of the voice. For example, the recognition unit 133 recognizes whether or not the utterer requests the generation of the response, using whether or not the utterer generates the voice toward the agent side (for example, output unit 145 of vehicle 100, camera 201, or the like) (whether or not voice is directed to direction of installation target), as the determination element. Alternatively, the recognition unit 133 may determine a difference between the composition information (pitch or the like) when the human utterers perform conversation and a case where the utterer generates the voice toward a machine such as the agent, using the determination model and recognize whether or not the utterer generates the utterance to the agent, that is, the utterer requests the generation of the response, on the basis of the determined result.

Furthermore, the recognition unit 133 may recognize the emotion of the utterer in the utterance generated by each utterer, as the property of the utterance. For example, the recognition unit 133 determines that the utterance has a feature amount different from that at the normal time, using the determination model and recognizes whether or not the utterer has a sense of urgency or the like, on the basis of the information.

Note that the recognition unit 133 may recognize the emotion of the utterance, on the basis of at least one of an expression of the utterer in the video, the movement of the lips, and the composition information of the voice in the utterance, in addition to the voice. For example, the recognition unit 133 may estimate how much sense of urgency the utterer has from the imaged expression of the utterer, using the image recognition model that determines the expression of the utterer.

The generation unit 134 generates the response to the recognized utterance, on the basis of the attribute of each utterer or the property of the utterance recognized by the recognition unit 133.

Note that the generation unit 134 determines the priority of the response to the recognized utterance, on the basis of the recognized attribute of each utterer or property of the utterance. An output control unit 135 to be described later outputs the response to the recognized utterance, according to the priority determined by the generation unit 134. That is, in the embodiment, the generation of the response is a concept including not only the specific content such as the answer to the utterance but also processing for determining the priority such as whether or not the response is returned (output) to the utterance or in what order the response is made to the plurality of utterances.

For example, the generation unit 134 may generate different responses according to whether or not the plurality of utterers requests the generation of the response. As an example, in a case of recognizing that the utterer does not speak to the agent, the generation unit 134 may not generate the response to the utterance or lower the priority of the generation of the reaction.

Furthermore, the generation unit 134 may generate the response to the recognized utterance, on the basis of the priority associated with the attribute of each utterer. That is, according to the order of the utterer, the generation unit 134 may determine the priority of generating the response and preferentially outputting the response to the higher-order utterer.

Furthermore, the generation unit 134 may generate the response to the recognized utterance, on the basis of the priority determined according to the emotion of each utterer. That is, the generation unit 134 may preferentially generate the response to the utterance recognized to have the sense of urgency or tightness.

Furthermore, the generation unit 134 may generate the response to the recognized utterance, on the basis of the information regarding the external environment acquired by the acquisition unit 131.

For example, in a case where the information indicating whether or not the predetermined situation defined in advance occurs is acquired as the information regarding the external environment, the generation unit 134 may generate a response corresponding to the predetermined situation, in preference to the response to the utterer. Specifically, in a case of detecting the approach of the emergency vehicle or the like, the generation unit 134 generates a response corresponding to the situation (stop of vehicle 100, stop of music, or the like).

Furthermore, in a case where the information regarding the time band or the weather is acquired as the information regarding the external environment, the generation unit 134 may generate a response corresponding to the time band or the weather. For example, in a case where a response to be generated in a midnight time band is defined, the generation unit 134 generates a response according to the definition.

Furthermore, the generation unit 134 may generate a response regarding the behavior of the vehicle 100, as the response to the recognized utterance. The response regarding the behavior of the vehicle is control for stopping the vehicle 100 as described above, automatic driving of the vehicle 100 according to setting of a destination, or the like.

The output control unit 135 performs control to output the response generated by the generation unit 134 to the output unit 145. For example, the output control unit 135 outputs the response to the recognized utterance, according to the priority determined by the generation unit 134. Furthermore, the output control unit 135 may perform control for outputting what information from what output unit 145, according to the priority. For example, the output control unit 135 may perform control for outputting information with high priority that is desirable to be quickly transmitted to the user from the voice output unit 147 as a voice and displaying other pieces of information on the display unit 146, for example. Furthermore, the output control unit 135 may control an output destination according to the priority for each user, for example, outputting a comment on the display unit 146 as a video, so as not to disturb a news voice, when traffic information news is broadcasted in response to a request by the user 10 with higher priority from among the plurality of users.

### (1-3. Procedure of Information Processing According to Embodiment)

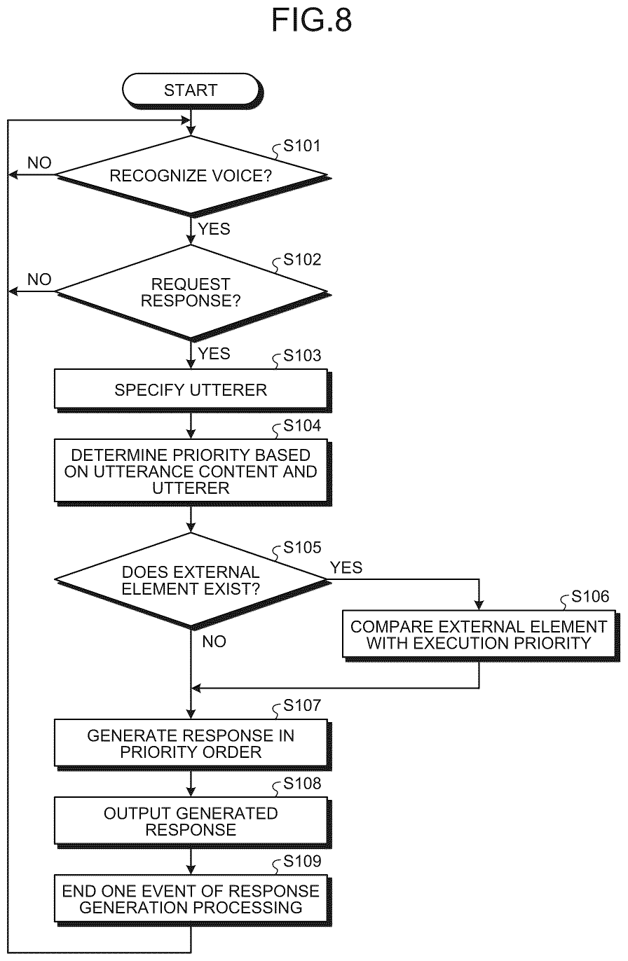

Next, an example of the flow of the information processing according to the embodiment will be described with reference to FIG. 8. FIG. 8 is a flowchart illustrating the flow of the information processing according to the embodiment.

As illustrated in FIG. 8, the vehicle 100 determines whether or not the voice of the user located in the vehicle 100 is recognized (Step S101). In a case where the voice is not recognized (Step S101, No), the vehicle 100 continues standby processing in order to recognize the voice.

On the other hand, in a case where the voice is recognized (Step S101; Yes), the vehicle 100 determines whether or not the voice requests the response by the agent (Step S102). In a case where it is determined that the voice does not request the response by the agent (Step S102; No), the vehicle 100 does not generate the response and continues the standby processing in order to recognize the voice.

On the other hand, in a case where it is determined that the response by the agent is requested (Step S102: Yes), the vehicle 100 specifies the utterer who has generated the voice, from among the plurality of utterers (Step S103). Moreover, the vehicle 100 determines the priority on the basis of the utterance content and the utterer (Step S104). For example, the vehicle 100 determines the priority on the basis of the property of the utterance and the attribute of the utterer.

Moreover, the vehicle 100 determines whether or not an external element exists, such as an approach of an emergency vehicle (Step S105). In a case where the external element exists (Step S105: Yes), the vehicle 100 compares the external element and an execution priority (Step S106). For example, if the external element is an element to which a significantly high priority is set, such as “the approach of the emergency vehicle”, the vehicle 100 increases the priority of generating a response to the external element.

Then, the vehicle 100 generates the response in order of the priority (Step S107). Subsequently, the vehicle 100 outputs the generated response according to the order of the priority (queue) (Step S108). As a result, the vehicle 100 determines that one event of response generation processing has ended (Step S109) and waits until a next voice is acquired.

### (1-4. Modification According to Embodiment)

The embodiment described above may involve a variety of different modifications. For example, the vehicle 100 may perform voice recognition using predetermined dictionary data, not only the lip reading, in the voice recognition.

For example, the vehicle 100 holds a facility that the user frequently uses and a term that the user frequently utters as the dictionary data. As a result, even in a case where the user utters a proper noun such as the facility, the vehicle 100 can specify the term with reference to the dictionary data. Therefore, it is possible to improve the accuracy of the voice recognition.

Furthermore, the vehicle 100 may improve the accuracy of the voice recognition using context information (context). For example, in a case where a proper noun (restaurant name) is uttered to the agent when the users talk about a restaurant or a meal in a conversation, the vehicle 100 estimates that there is a high possibility that the proper noun indicates a nearby restaurant from the context information and complements the voice recognition using a name of the nearby restaurant or the like. As a result, the vehicle 100 can lower a probability that an error regarding the voice recognition is returned and can improve usability.

Furthermore, in the embodiment, the inside of the vehicle 100 is exemplified as the space where the plurality of utterers is located. However, the information processing according to the embodiment is applicable to a space other than the automobiles. For example, the information processing according to the embodiment may be executed in a conference room of a meeting in which a plurality of people participates or may be used for a web conference or the like.

Furthermore, in the embodiment, an example has been described in which the vehicle 100 reads the lips of the utterer. However, the vehicle 100 may read not only the movement of the lips but also any information forming the expression of the utterer, such as facial muscles of the utterer. That is, the vehicle 100 may not only read the utterance content from the movement of the lips but also read the utterance content from any information that can be acquired by a sensor of a camera that images the utterer or the like.

### 2. Other Embodiments

The configuration of the information processing device or the like indicated in each embodiment described above may be implemented in various different modes other than each embodiment described above.

### (2-1. Configuration of Imaging Device According to Modification)

In the embodiment, an example has been described in which the imaging device 30 illustrated in FIG. 3 is an example of the cameras 201 and 202, that is, is implemented by the RGB stereo camera 31 or the like. Here, the imaging device 30 according to the present disclosure may be configured as a so-called AI image sensor, in which an automatic recognition model is incorporated in an image sensor, that can detect and image an object by executing inference processing using a model. In this case, without the control by the vehicle 100, the imaging device 30 can recognize an object such as a person or a lip and automatically image the recognized object.

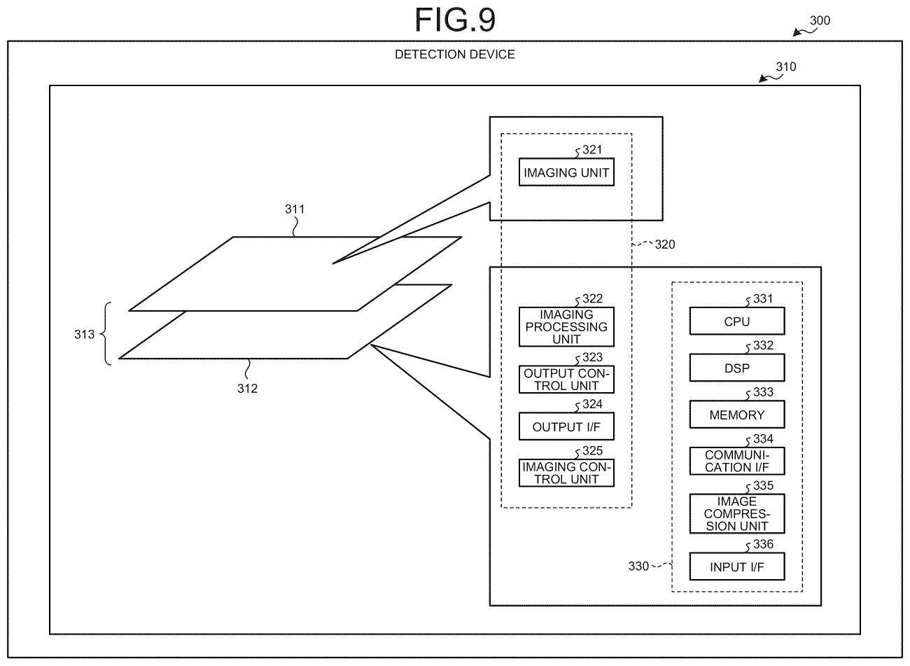

Next, this point will be described with reference to FIG. 9. FIG. 9 is a diagram illustrating a configuration example of the imaging device according to the modification. In FIG. 9, a detection device 300 is illustrated as an example of the imaging device according to the modification.

As illustrated in FIG. 9, the detection device 300 includes an image sensor 310. Note that, although not illustrated in FIG. 9, the detection device 300 includes an optical system that implements as functions as a digital camera, a communication system that communicates with the vehicle 100, the cloud server, or the like, or the like.

The image sensor 310 is, for example, a complementary metal oxide semiconductor (CMOS) image sensor including a chip, receives incident light from the optical system, performs photoelectric conversion, and outputs image data corresponding to the incident light.

The image sensor 310 has a configuration in which a pixel chip 311 and a logic chip 312 are integrated via a connection unit 313. Furthermore, the image sensor 310 includes an image processing block 320 and a signal processing block 330.

The pixel chip 311 includes an imaging unit 321. The imaging unit 321 includes a plurality of pixels two-dimensionally arranged. The imaging unit 321 is driven by an imaging processing unit 322 and captures an image.

The imaging processing unit 322 executes imaging processing related to capturing of the image by the imaging unit 321, such as driving of the imaging unit 321, analog to digital (AD) conversion of an analog image signal output from the imaging unit 321, or imaging signal processing, under control of an imaging control unit 325.

The captured image output by the imaging processing unit 322 is supplied to an output control unit 323 and is supplied to an image compression unit 335. Furthermore, the imaging processing unit 322 transfers the captured image to an output I/F 324.

The output control unit 323 performs output control for selectively outputting the captured image from the imaging processing unit 322 and a signal processing result from the signal processing block 330 from the output I/F 324 to the outside (vehicle 100 or the like in embodiment). That is, the output control unit 323 performs control so as to selectively output at least one of behavior data indicating a behavior of the detected object and an image.

Specifically, the output control unit 323 selects the captured image from the imaging processing unit 322 or the signal processing result from the signal processing block 330 and supplies the selected one to the output I/F 324.

For example, in a case where the vehicle 100 requests both of the image data and the behavior data, the output I/F 324 can output both pieces of data. Alternatively, in a case where the vehicle 100 requests only the behavior data, the output I/F 324 can output only the behavior data. That is, in a case where the captured image itself is not needed for secondary analysis, the output I/F 324 can output only the signal processing result (behavior data). Therefore, an amount of data to be output to the outside can be reduced.

As illustrated in FIG. 9, the signal processing block 330 includes a CPU 331, a DSP 332, a memory 333, a communication I/F 334, the image compression unit 335, and an input I/F 336.

For example, the CPU 331 and the DSP 332 recognize an object from an image included in the image compression unit 335, using a preliminary learning model that is incorporated in the memory 333 via the communication I/F 334 or the input I/F 336. Furthermore, the CPU 331 and the DSP 332 acquire behavior data of a behavior of the recognized object. In other words, the signal processing block 330 detects the behavior of the object included in the image, using the preliminary learning model that recognizes the object, in cooperation of each functional unit.

With the above configuration, the detection device 300 according to the embodiment can selectively output the image data obtained by the image processing block 320 and the behavior data obtained by the signal processing block 330 to the outside.

Note that the detection device 300 may include various sensors, in addition to the configuration illustrated in FIG. 9. For example, the detection device 300 may include a ToF sensor that is a depth sensor that measures a distance to an object located in a space. As a result, the detection device 300 can acquire not only two-dimensional point cloud data indicated in the image and three-dimensional point cloud data to which height information is added, as the behavior data.

The configuration illustrated in FIG. 9 corresponds to, for example, a partial configuration of the vehicle 100 illustrated in FIG. 4. For example, the detection device 300 can execute processing of some of the acquisition unit 131, the specification unit 132, and the recognition unit 133. In this case, the information processing according to the present disclosure may be executed by the vehicle 100 and the detection device 300 in cooperation.

### (2-2. Configuration of Mobile Body)

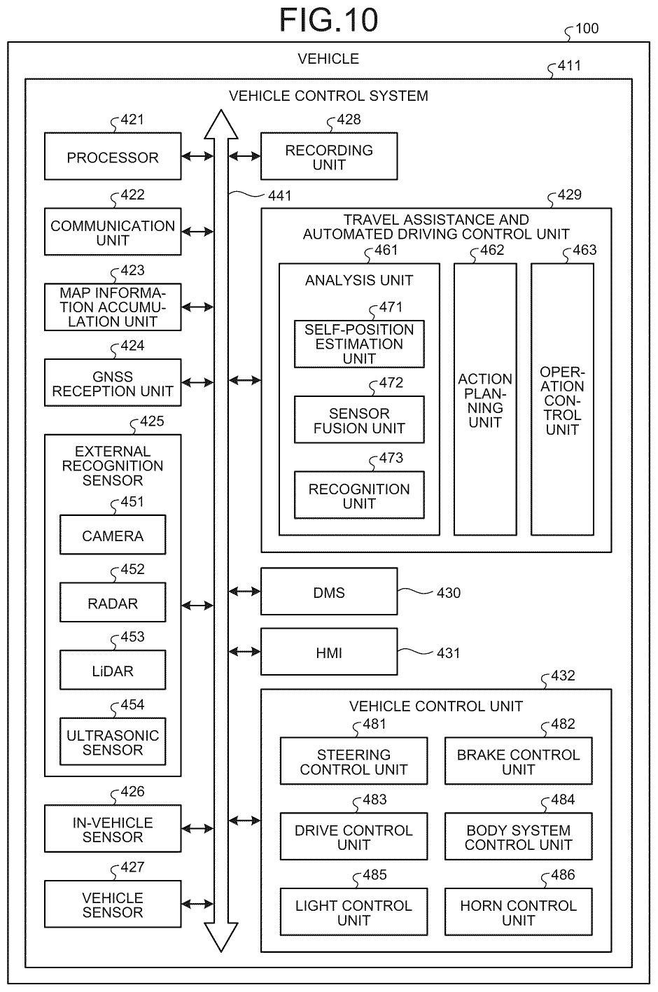

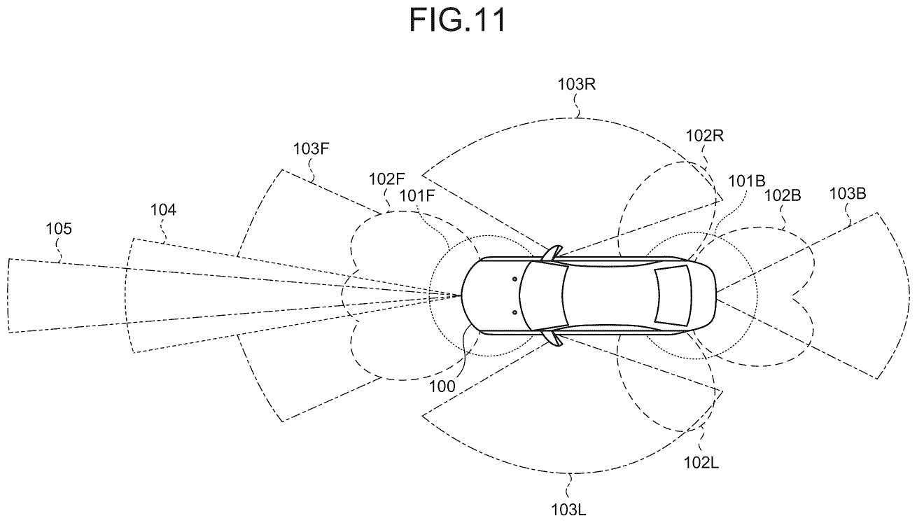

For example, the vehicle 100 may be implemented by an autonomous mobile body that performs autonomous driving. In this case, the vehicle 100 may include the configurations illustrated in FIGS. 10 and 11, in addition to the configuration illustrated in FIG. 4. Note that, each unit below may be included in each unit illustrated in FIG. 4, for example.

That is, the vehicle 100 of the present technology can be configured as a vehicle control system 411 shown below. FIG. 10 is a block diagram illustrating a configuration example of a schematic function of the vehicle control system 411 to which the present technology may be applied.

The vehicle control system 411 is provided in a vehicle 100 and executes processing related to travel assistance and automated driving of the vehicle 100.

The vehicle control system 411 includes a vehicle control electronic control unit (ECU) 421, a communication unit 422, a map information accumulation unit 423, a global navigation satellite system (GNSS) reception unit 424, an external recognition sensor 425, an in-vehicle sensor 426, a vehicle sensor 427, a recording unit 428, a travel assistance and automated driving control unit 429, a driver monitoring system (DMS) 430, a human machine interface (HMI) 431, and a vehicle control unit 432.

The vehicle control ECU 421, the communication unit 422, the map information accumulation unit 423, the GNSS reception unit 424, the external recognition sensor 425, the in-vehicle sensor 426, the vehicle sensor 427, the recording unit 428, the travel assistance and automated driving control unit 429, the driver monitoring system (DMS) 30, the human machine interface (HMI) 431, and the vehicle control unit 432 are communicably connected to each other via a communication network 441. The communication network 441 includes, for example, an in-vehicle communication network, a bus, or the like conforming to a digital bidirectional communicate standard such as a controller area network (CAN), a local interconnect network (LIN), a local area network (LAN), the FlexRay (registered trademark), or the Ethernet (registered trademark). The communication network 441 may be selectively used depending on a type of data to be communicated, and for example, the CAN is applied to data related to vehicle control, and the Ethernet is applied to large-capacity data. Note that each unit of the vehicle control system 411 may be directly connected using wireless communication that assumes communication at a relatively short distance, for example, near field communication (NFC) or the Bluetooth (registered trademark), not via the communication network 441.

Note that, hereinafter, in a case where each unit of the vehicle control system 411 performs communication via the communication network 441, the description of the communication network 441 is omitted. For example, in a case where the vehicle control ECU 421 and the communication unit 422 communicate via the communication network 441, it is simply described that the vehicle control ECU 421 and the communication unit 422 communicate.

The vehicle control ECU 421 includes various processors, for example, a central processing unit (CPU), a micro processing unit (MPU), or the like. The vehicle control ECU 421 controls all or some of functions of the vehicle control system 411.

The communication unit 422 communicates with various devices inside and outside the vehicle, other vehicles, a server, a base station, or the like and transmits and receives various types of data. At this time, the communication unit 422 can perform communication using a plurality of communication methods.

Communication with outside the vehicle that can be performed by the communication unit 422 will be schematically described. For example, the communication unit 422 communicates with a server existing on an external network (hereinafter, referred to as external server) or the like, via a base station or an access point, with a wireless communication method such as the 5th generation mobile communication system (5G), the long term evolution (LTE), or the dedicated short range communications (DSRC). The external network with which the communication unit 422 communicates is, for example, the Internet, a cloud network, or a network unique to a company, or the like. A communication method for performing communication with the external network by the communication unit 422 is not particularly limited, as long as the communication method is a wireless communication method that can perform digital bidirectional communication at a communication speed equal or more than a predetermined speed and at a distance equal to or longer than a predetermined distance.

Furthermore, for example, the communication unit 422 can communicate with a terminal existing near the own vehicle, using the peer to peer (P2P) technology. The terminal existing near the own vehicle is, for example, a terminal attached to a mobile body that is moving at a relatively low speed, such as a pedestrian or a bicycle, a terminal installed at a fixed position in a store or the like, or a machine type communication (MTC) terminal. Moreover, the communication unit 422 can perform V2X communication. The V2X communication is communication between the own vehicle and others, for example, vehicle to vehicle communication with another vehicle, vehicle to infrastructure communication with a roadside device or the like, vehicle to home communication with home, vehicle to pedestrian communication with a terminal owned by a pedestrian, or the like.

The communication unit 422 can receive a program used to update software for controlling an operation of the vehicle control system 411 from outside (Over The Air), for example. The communication unit 422 can further receive map information, traffic information, information around the vehicle 100, or the like from outside. Furthermore, for example, the communication unit 422 can transmit information regarding the vehicle 100, the information around the vehicle 100, or the like to the outside. The information regarding the vehicle 100 to be transmitted to the outside by the communication unit 422 is, for example, data indicating a state of the vehicle 100, a recognition result by a recognition unit 473, or the like. Moreover, for example, the communication unit 422 performs communication corresponding to a vehicle emergency call system such as an eCall.

The communication with inside of the vehicle that can be performed by the communication unit 422 will be schematically described. The communication unit 422 can communicate with each device in the vehicle, for example, using wireless communication. The communication unit 422 can perform wireless communication with a device in the vehicle, for example, with a communication method capable of performing digital bidirectional communication at a communication speed equal to or higher than the predetermined speed through wireless communication, such as a wireless LAN, the Bluetooth, NFC, or a wireless USB (WUSB). The communication unit 422 is not limited to this, and the communication unit 422 can communicate with each device in the vehicle using wired communication. For example, the communication unit 422 can communicate with each device in the vehicle through wired communication via a cable connected to a connection terminal (not illustrated). The communication unit 422 can communicate with each device in the vehicle, with a communication method capable of performing the digital bidirectional communication at the communication speed equal to or higher than the predetermined speed through wired communication, for example, a universal serial bus (USB), the High-definition multimedia interface (HDMI) (registered trademark), and a mobile high-definition link (MHL).

Here, the device in the vehicle indicates, for example, a device that is not connected to the communication network 441 in the vehicle. As the device in the vehicle, for example, a mobile device or a wearable device owned by an occupant such as a driver, an information device brought into the vehicle and temporarily provided in the vehicle, or the like is assumed.

For example, the communication unit 422 receives electromagnetic waves transmitted from a radio wave beacon, an optical beacon, or a vehicle information and communication system (VICS) (registered trademark) such as FM multiplex broadcasting.

The map information accumulation unit 423 accumulates one or both of a map acquired from outside and a map created in the vehicle 100. For example, the map information accumulation unit 423 accumulates a three-dimensional high-precision map, a global map that has lower accuracy than the high-precision map and covers a wider area, or the like.

The high-precision map is, for example, a dynamic map, a point cloud map, a vector map, or the like. The dynamic map is, for example, a map including four layers including dynamic information, semi-dynamic information, semi-static information, and static information and is provided from an external server or the like to the vehicle 100. The point cloud map is a map including a point cloud (point cloud data). Here, it is assumed that the vector map indicated a map adapted to an advanced driver assistance system (ADAS) in which traffic information such as positions of a lane and a signal is associated with the point cloud map.

The point cloud map and the vector map may be provided, for example, from an external server or the like, and may be created by the vehicle 100 as a map for matching with a local map to be described later, on the basis of sensing results of a radar 452, a LiDAR 453, or the like and accumulated in the map information accumulation unit 423. Furthermore, in a case where the high-precision map is provided from the external server or the like, in order to reduce a communication capacity, for example, map data of several hundred meters square regarding a planned route where the vehicle 100 will travel is acquired from the external server or the like.

The position information acquisition unit 424 receives a GNSS signal from a GNSS signal satellite and acquires position information of the vehicle 100. The received GNSS signal is supplied to the travel assistance and automated driving control unit 429. Note that the position information acquisition unit 424 may acquire the position information, for example, using a beacon, without limiting to the method using the GNSS signal.

The external recognition sensor 425 includes various sensors used to recognize an external situation of the vehicle 100 and supplies sensor data from each sensor to each unit of the vehicle control system 411. The type and the number of sensors included in the external recognition sensor 425 may be arbitrary.

For example, the external recognition sensor 425 includes a camera 451, a radar 452, a light detection and ranging, laser imaging detection and ranging (LiDAR) 453, and an ultrasonic sensor 454. Without limiting to this, the external recognition sensor 425 may have a configuration including one or more sensors of the camera 451, the radar 452, the LiDAR 453, and the ultrasonic sensor 454. The numbers of cameras 451, radars 452, LiDARs 453, and ultrasonic sensors 454 are not particularly limited as long as they can be practically installed in the vehicle 100. Furthermore, the type of the sensor included in the external recognition sensor 425 is not limited to this example, and the external recognition sensor 425 may include another type of sensor. An example of a sensing region of each sensor included in the external recognition sensor 425 will be described later.

Note that an imaging method of the camera 451 is not particularly limited as long as the imaging method is an imaging method capable of performing distance measurement. For example, as the camera 451, cameras of various imaging methods such as a time of flight (ToF) camera, a stereo camera, a monocular camera, and an infrared camera can be applied as necessary. The camera 451 is not limited to this, and the camera 451 may simply acquire a captured image regardless of distance measurement.

Furthermore, for example, the external recognition sensor 425 can include an environment sensor for detecting an environment for the vehicle 100. The environment sensor is a sensor for detecting an environment such as weather, climate, or brightness, and can include various sensors such as a raindrop sensor, a fog sensor, a sunshine sensor, a snow sensor, and an illuminance sensor, for example.

Moreover, for example, the external recognition sensor 425 includes a microphone used to detect a sound around the vehicle 100, a position of a sound source, or the like.

The in-vehicle sensor 426 includes various sensors for detecting information regarding the inside of the vehicle, and supplies sensor data from each sensor to each unit of the vehicle control system 411. The types and the number of various sensors included in the in-vehicle sensor 426 are not particularly limited as long as they can be practically installed in the vehicle 100.

For example, the in-vehicle sensor 426 can include one or more sensors of a camera, a radar, a seating sensor, a steering wheel sensor, a microphone, and a biological sensor. For example, as the camera included in the in-vehicle sensor 426, cameras of various imaging methods capable of performing distance measurement such as a time of flight (ToF) camera, a stereo camera, a monocular camera, and an infrared camera can be used. The camera is not limited to this, and the camera included in the in-vehicle sensor 426 may simply acquire a captured image regardless of distance measurement. The biological sensor included in the in-vehicle sensor 426 is provided in, for example, a seat, a steering wheel, or the like, and detects various types of biological information of the occupant such as the driver.

The vehicle sensor 427 includes various sensors for detecting the state of the vehicle 100, and supplies sensor data from each sensor to each unit of the vehicle control system 411. The types and the number of various sensors included in the vehicle sensor 427 are not particularly limited as long as they can be practically installed in the vehicle 100.

For example, the vehicle sensor 427 includes a speed sensor, an acceleration sensor, an angular velocity sensor (gyro sensor), and an inertial measurement unit (IMU) as an integrated sensor including these sensors. For example, the vehicle sensor 427 includes a steering angle sensor that detects a steering angle of a steering wheel, a yaw rate sensor, an accelerator sensor that detects an operation amount of an accelerator pedal, and a brake sensor that detects an operation amount of a brake pedal. For example, the vehicle sensor 427 includes a rotation sensor that detects the number of rotations of an engine or a motor, an air pressure sensor that detects the air pressure of a tire, a slip rate sensor that detects a slip rate of the tire, and a wheel speed sensor that detects a rotation speed of a wheel. For example, the vehicle sensor 427 includes a battery sensor that detects a remaining amount and a temperature of a battery, and an impact sensor that detects an external impact.

The recording unit 428 includes at least one of a non-volatile storage medium or a volatile storage medium, and stores data and a program. The recording unit 428 is used as, for example, an electrically erasable programmable read only memory (EEPROM) and a random access memory (RAM), and a magnetic storage device such as a hard disc drive (HDD), a semiconductor storage device, an optical storage device, and a magneto-optical storage device can be applied as the storage medium. The recording unit 428 records various programs and data used by each unit of the vehicle control system 411. For example, the recording unit 428 includes an event data recorder (EDR) and a data storage system for automated driving (DSSAD), and records information of the vehicle 100 before and after an event such as an accident and biological information acquired by the in-vehicle sensor 426.

The travel assistance and automated driving control unit 429 controls travel assistance and automated driving of the vehicle 100. For example, the travel assistance and automated driving control unit 429 includes an analysis unit 461, an action planning unit 462, and an operation control unit 463.

The analysis unit 461 executes analysis processing on the vehicle 100 and a situation around the vehicle 100. The analysis unit 461 includes a self-position estimation unit 471, a sensor fusion unit 472, and the recognition unit 473.

The self-position estimation unit 471 estimates a self-position of the vehicle 100, on the basis of the sensor data from the external recognition sensor 425 and the high-precision map accumulated in the map information accumulation unit 423. For example, the self-position estimation unit 471 generates the local map on the basis of the sensor data from the external recognition sensor 425, and estimates the self-position of the vehicle 100 by matching the local map with the high-precision map. The position of the vehicle 100 is based on, for example, a center of a rear wheel pair axle.

The local map is, for example, a three-dimensional high-precision map created using a technology such as simultaneous localization and mapping (SLAM), an occupancy grid map, or the like. The three-dimensional high-precision map is, for example, the above-described point cloud map or the like. The occupancy grid map is a map in which a three-dimensional or two-dimensional space around the vehicle 100 is divided into grids (lattices) with a predetermined size, and an occupancy state of an object is represented in units of grids. The occupancy state of the object is represented by, for example, the presence or absence or an existence probability of the object. The local map is also used for detection processing and recognition processing on the situation outside the vehicle 100 by the recognition unit 473, for example.

Note that the self-position estimation unit 471 may estimate the self-position of the vehicle 100 on the basis of the GNSS signal and the sensor data from the vehicle sensor 427.

The sensor fusion unit 472 executes sensor fusion processing for combining a plurality of different types of sensor data (for example, image data supplied from camera 451 and sensor data supplied from radar 452), to acquire new information. Methods for combining different types of sensor data include integration, fusion, association, and the like.

The recognition unit 473 executes the detection processing for detecting the situation outside the vehicle 100 and the recognition processing for recognizing the situation outside the vehicle 100.

For example, the recognition unit 473 executes the detection processing and the recognition processing on the situation outside the vehicle 100, on the basis of the information from the external recognition sensor 425, the information from the self-position estimation unit 471, the information from the sensor fusion unit 472, or the like.

Specifically, for example, the recognition unit 473 executes the detection processing, the recognition processing, or the like on the object around the vehicle 100. The object detection processing is, for example, processing for detecting presence or absence, size, shape, position, motion, or the like of an object. The object recognition processing is, for example, processing for recognizing an attribute such as a type of an object or identifying a specific object. The detection processing and the recognition processing, however, are not necessarily clearly separated and may overlap.

For example, the recognition unit 473 detects an object around the vehicle 100 by performing clustering to classify a point cloud based on the sensor data by the LiDAR 453, the radar 452, or the like for each cluster of a point cloud. As a result, the presence or absence, size, shape, and position of the object around the vehicle 100 are detected.

For example, the recognition unit 473 detects a motion of the object around the vehicle 100 by performing tracking for following a motion of the cluster of the point cloud classified by clustering. As a result, a speed and a traveling direction (movement vector) of the object around the vehicle 100 are detected.

For example, the recognition unit 473 detects or recognizes a vehicle, a person, a bicycle, an obstacle, a structure, a road, a traffic light, a traffic sign, a road sign, and the like with respect to the image data supplied from the camera 451. Furthermore, the type of the object around the vehicle 100 may be recognized by executing recognition processing such as semantic segmentation.

For example, the recognition unit 473 can execute processing for recognizing traffic rules around the vehicle 100 on the basis of the map accumulated in the map information accumulation unit 423, the estimation result of the self-position by the self-position estimation unit 471, and the recognition result of the object around the vehicle 100 by the recognition unit 473. Through this processing, the recognition unit 473 can recognize a position and state of a signal, content of traffic signs and road signs, content of traffic regulations, travelable lanes, and the like.

For example, the recognition unit 473 can execute the recognition processing on a surrounding environment of the vehicle 100. As the surrounding environment to be recognized by the recognition unit 473, a weather, a temperature, a humidity, brightness, a road surface condition, or the like are assumed.

The action planning unit 462 creates an action plan for the vehicle 100. For example, the action planning unit 462 creates the action plan by executing processing of route planning and route following.

Note that the route planning (Global path planning) is processing for planning a rough route from a start to a goal. This route planning is called track planning, and also includes processing of track generation (local path planning) that allows safe and smooth traveling near the vehicle 100, in consideration of motion characteristics of the vehicle 100 in the route planned by the route planning. The route planning may be distinguished as long-term route planning, and startup generation may be distinguished as short-term route planning or local route planning. A safety-first route represents a concept similar to the startup generation, the short-term route planning, or the local route planning.

The route following is processing for planning an operation for safely and accurately traveling on the route planned by the route planning within a planned time. The action planning unit 462 can calculate a target speed and a target angular velocity of the vehicle 100, on the basis of the result of the route following processing, for example.

The operation control unit 463 controls the operation of the vehicle 100 in order to achieve the action plan created by the action planning unit 462.

For example, the operation control unit 463 controls a steering control unit 481, a brake control unit 482, and a drive control unit 483 included in the vehicle control unit 432 to be described later, to control acceleration/deceleration and the direction so that the vehicle 100 travels on a track calculated by the track planning. For example, the operation control unit 463 performs cooperative control for the purpose of implementing functions of the ADAS such as collision avoidance or impact mitigation, following traveling, vehicle speed maintaining traveling, collision warning of the own vehicle, or lane deviation warning of the host vehicle. For example, the operation control unit 463 performs cooperative control for the purpose of automated driving or the like in which a vehicle autonomously travels without depending on an operation of a driver.

The DMS 430 executes driver authentication processing, recognition processing on a state of the driver, or the like, on the basis of the sensor data from the in-vehicle sensor 426, the input data input to the HMI 431 to be described later, or the like. In this case, as the state of the driver to be recognized by the DMS 430, for example, a physical condition, an alertness, a concentration degree, a fatigue degree, a line-of-sight direction, a degree of drunkenness, a driving operation, a posture, or the like are assumed.

Note that the DMS 430 may execute processing for authenticating an occupant other than the driver, and processing for recognizing a state of the occupant. Furthermore, for example, the DMS 430 may execute processing for recognizing a situation in the vehicle, on the basis of the sensor data from the in-vehicle sensor 426. As the situation in the vehicle to be recognized, for example, a temperature, a humidity, brightness, odor, or the like are assumed.

The HMI 431 inputs various types of data, instructions, or the like, and presents various types of data to the driver or the like.

The input of the data by the HMI 431 will be schematically described. The HMI 431 includes an input device for a person to input data. The HMI 431 generates an input signal on the basis of the data, the instruction, or the like input with the input device, and supplies the input signal to each unit of the vehicle control system 411. The HMI 431 includes, for example, an operator such as a touch panel, a button, a switch, or a lever as the input device. Without being limited to this, the HMI 431 may further include an input device capable of inputting information by a method using voice or gesture, other than a manual operation. Moreover, the HMI 431 may use, for example, a remote control device using infrared rays or radio waves, or an external connection device such as a mobile device or a wearable device corresponding to the operation of the vehicle control system 411, as the input device.

The presentation of data by the HMI 431 will be schematically described. The HMI 431 generates visual information, auditory information, and haptic information regarding an occupant or outside of a vehicle. Furthermore, the HMI 431 performs output control for controlling output, output content, an output timing, an output method, or the like of each piece of generated information. The HMI 431 generates and outputs, for example, information indicated by an image or light of an operation screen, a state display of the vehicle 100, a warning display, a monitor image indicating a situation around the vehicle 100, or the like, as the visual information. Furthermore, the HMI 431 generates and outputs information indicated by sounds such as voice guidance, a warning sound, or a warning message, for example, as the auditory information. Moreover, the HMI 431 generates and outputs, for example, information given to a tactile sense of an occupant by force, vibration, motion, or the like as the haptic information.

As an output device with which the HMI 431 outputs the visual information, for example, a display device that presents the visual information by displaying an image by itself or a projector device that presents the visual information by projecting an image can be applied. Note that the display device may be a device that displays the visual information in the field of view of the occupant, such as a head-up display, a transmissive display, or a wearable device having an augmented reality (AR) function, for example, in addition to a display device having an ordinary display. Furthermore, the HMI 431 can use a display device included in a navigation device, an instrument panel, a camera monitoring system (CMS), an electronic mirror, a lamp, or the like provided in the vehicle 100, as the output device that outputs the visual information.

As an output device with which the HMI 431 outputs the auditory information, for example, an audio speaker, a headphone, or an earphone can be applied.

As an output device with which the HMI 431 outputs the haptic information, for example, a haptic element using a haptic technology can be applied. The haptic element is provided, for example, in a portion to be touched by the occupant of the vehicle 100, such as a steering wheel or a seat.

The vehicle control unit 432 controls each unit of the vehicle 100. The vehicle control unit 432 includes the steering control unit 481, the brake control unit 482, the drive control unit 483, a body system control unit 484, a light control unit 485, and a horn control unit 486.

The steering control unit 481 performs detection, control, or the like of a state of a steering system of the vehicle 100. The steering system includes, for example, a steering mechanism including a steering wheel or the like, an electric power steering, or the like. The steering control unit 481 includes, for example, a control unit such as an ECU that controls the steering system, an actuator that drives the steering system, or the like.

The brake control unit 482 performs detection, control, or the like of a state of a brake system of the vehicle 100. The brake system includes, for example, a brake mechanism including a brake pedal or the like, an antilock brake system (ABS), a regenerative brake mechanism, or the like. The brake control unit 482 includes, for example, a control unit such as an ECU that controls the brake system, or the like.

The drive control unit 483 performs detection, control, or the like of a state of a drive system of the vehicle 100. The drive system includes, for example, an accelerator pedal, a driving force generation device for generating a driving force such as an internal combustion engine or a driving motor, a driving force transmission mechanism for transmitting the driving force to wheels, or the like. The drive control unit 483 includes, for example, a control unit such as an ECU that controls the drive system, or the like.

The body system control unit 484 performs detection, control, or the like of a state of a body system of the vehicle 100. The body system includes, for example, a keyless entry system, a smart key system, a power window device, a power seat, an air conditioner, an airbag, a seat belt, a shift lever, or the like. The body system control unit 484 includes, for example, a control unit such as an ECU that controls the body system, or the like.

The light control unit 485 performs detection, control, or the like of states of various lights of the vehicle 100. As the lights to be controlled, for example, a headlight, a backlight, a fog light, a turn signal, a brake light, a projection light, a bumper indicator, or the like are assumed. The light control unit 485 includes a control unit such as an ECU that performs light control, or the like.

The horn control unit 486 performs detection, control, or the like of a state of a car horn of the vehicle 100. The horn control unit 486 includes, for example, a control unit such as an ECU that controls the car horn, or the like.

FIG. 11 is a diagram illustrating an example of a sensing region by the camera 451, the radar 452, the LiDAR 453, the ultrasonic sensor 454, or the like of the external recognition sensor 425 in FIG. 10. Note that FIG. 11 schematically illustrates a state of the vehicle 100 as viewed from above, where a left end side is the front end (front) side of the vehicle 100, and a right end side is the rear end (rear) side of the vehicle 100.

Sensing regions 101F and 101B illustrate examples of the sensing region of the ultrasonic sensor 454. The sensing region 101F covers a region around the front end of the vehicle 100 by the plurality of ultrasonic sensors 454. The sensing region 101B covers a region around the rear end of the vehicle 100 by the plurality of ultrasonic sensors 454.

Sensing results in the sensing regions 101F and 101B are used, for example, for parking assistance of the vehicle 100 or the like.

Sensing regions 102F to 102B illustrate examples of the sensing region of the radar 452 for short distance or medium distance. The sensing region 102F covers a position farther than the sensing region 101F, on the front side of the vehicle 100. The sensing region 102B covers a position farther than the sensing region 101B, on the rear side of the vehicle 100. The sensing region 102L covers a region around the rear side of a left side surface of the vehicle 100. The sensing region 102R covers a region around the rear side of a right side surface of the vehicle 100.

A sensing result in the sensing region 102F is used for, for example, detection of a vehicle, a pedestrian, or the like existing on the front side of the vehicle 100, or the like. A sensing result in the sensing region 102B is used for, for example, a function for preventing a collision of the rear side of the vehicle 100, or the like. The sensing results in the sensing regions 102L and 102R are used for, for example, detection of an object in a blind spot on the sides of the vehicle 100, or the like.

Sensing regions 103F to 103B illustrate examples of the sensing regions by the camera 451. The sensing region 103F covers a position farther than the sensing region 102F, on the front side of the vehicle 100. The sensing region 103B covers a position farther than the sensing region 102B, on the rear side of the vehicle 100. The sensing region 103L covers a region around the left side surface of the vehicle 100. The sensing region 103R covers a region around the right side surface of the vehicle 100.

A sensing result in the sensing region 103F can be used for, for example, recognition of a traffic light or a traffic sign, a lane departure prevention assist system, and an automated headlight control system. A sensing result in the sensing region 103B can be used for, for example, parking assistance, a surround view system, or the like. Sensing results in the sensing regions 103L and 103R can be used for, for example, a surround view system.

A sensing region 104 illustrates an example of the sensing region of the LiDAR 453. The sensing region 104 covers a position farther than the sensing region 103F, on the front side of the vehicle 100. On the other hand, the sensing region 104 has a narrower range in a left-right direction than the sensing region 103F.

The sensing result in the sensing region 104 is used to detect an object such as a surrounding vehicle, for example.

A sensing region 105 illustrates an example of the sensing region of the long-distance radar 452. The sensing region 105 covers a position farther than the sensing region 104, on the front side of the vehicle 100. On the other hand, the sensing region 105 has a narrower range in the left-right direction than the sensing region 104.

A sensing result in the sensing region 105 is used, for example, for adaptive cruise control (ACC), emergency braking, collision avoidance, or the like.

Note that the respective sensing regions of the sensors: the camera 451; the radar 452; the LiDAR 453; and the ultrasonic sensor 454, included in the external recognition sensor 425 may have various configurations other than those in FIG. 2. Specifically, the ultrasonic sensor 454 may also perform sensing on the sides of the vehicle 100, or the LiDAR 453 may perform sensing on the rear side of the vehicle 100.

Furthermore, an installation position of each sensor is not limited to each example described above. Furthermore, the number of sensors may be one or plural.

### (2-3. Others)

Of each processing described in each embodiment described above, all or a part of the processing that has been described as being automatically executed can be manually executed, or all or a part of the processing that has been described as being manually executed can be automatically executed. In addition, the processing procedure, the specific name, and information including various types of data and parameters described herein and illustrated in the drawings can be arbitrarily changed unless otherwise specified. For example, various types of information illustrated in each drawing is not limited to the information illustrated in the drawings.

Furthermore, each component of each device illustrated is functionally conceptual and is not necessarily physically configured as illustrated. That is, a specific form of distribution and integration of each device is not limited to those illustrated, and all or a part thereof can be functionally or physically distributed and integrated in an arbitrary unit according to various loads, usage conditions, and the like.

Furthermore, each embodiment and modification described above can be appropriately combined within a range in which processing contents do not contradict. Furthermore, in the embodiment described above, an automobile has been described as an example of the mobile body. However, the information processing according to the present disclosure is applicable to a mobile body other than the automobile. For example, the mobile body may be a small vehicle such as an automated bicycle or an automated three-wheels cycle, a large vehicle such as a bus or a truck, a large airframe such as a ship or an aircraft, or an autonomous mobile body such as a robot or a drone. Furthermore, the vehicle 100 is not necessarily integrated with the mobile body and may be, for example, a cloud server or the like that acquires information from the mobile body via the network N and determines a removal range on the basis of the acquired information.

Furthermore, the effects described herein are merely examples and are not limited, and other effects may be achieved.

### 3. Effects of Information Processing Device According to Present Disclosure

As described above, the information processing device (vehicle 100 in embodiment) according to the present disclosure includes the acquisition unit (acquisition unit 131 in embodiment), the specification unit (specification unit 132 in embodiment), the recognition unit (recognition unit 133 in embodiment), and the generation unit (generation unit 134 in embodiment). For example, the acquisition unit acquires the voices generated by the plurality of utterers and the video in which the state where the utterer generates the utterance is imaged. The specification unit specifies each of the plurality of utterers, on the basis of the acquired voice and video. The recognition unit recognizes each of the utterance generated by the specified utterer, the attribute of each utterer, or the property of the utterance. The generation unit generates the response to the recognized utterance, on the basis of the attribute of each utterer or the property of the utterance that is recognized.

In this way, the information processing device according to the present disclosure accurately recognizes each utterance content by acquiring not only the voice but also the video of the plurality of utterers and specifying the utterer using the acquired video. Furthermore, the information processing device can return the optimal response to the recognized voice, by generating the response on the basis of the attribute of each utterer and the property of the utterance.

Furthermore, the generation unit determines the priority of the response to the recognized utterance, on the basis of the recognized attribute of each utterer or property of the utterance. Furthermore, the information processing device further includes the output control unit (output control unit 135 in embodiment) that outputs the response to the recognized utterance, according to the priority determined by the generation unit.

In this way, the information processing device can generate the optimal response to the target to be responded, even if the utterances of the plurality of utterers are simultaneously received, by determining the priority on the basis of the attribute of each utterer or the property of the utterance.

Furthermore, the acquisition unit acquires the video in which the lips of the utterer are imaged, as the video. The specification unit specifies each of the plurality of utterers, on the basis of the video in which the lips of the utterer are imaged.

In this way, the information processing device can improve accuracy of specification, by specifying the utterer using not only the voice but also the video including the movement of the lips of the utterer.

Furthermore, the recognition unit recognizes each utterance generated by each utterer, on the basis of the voice generated by each utterer or the movement of the lips of each utterer.

In this way, the information processing device can reliably perform the voice recognition according to the intention of the utterer, by recognizing the utterance from not only the voice but also the video using the lip reading technology.

Furthermore, the acquisition unit acquires the video in which the state where the utterer generates the utterance is imaged, after detecting the utterer by temperature detection.

In this way, by performing the voice recognition after recognizing the person who is actually located, for example, the information processing device can accurately recognize only the utterance of the located person, without erroneously recognizing a voice of a television video reproduced by the person as the utterer.

Furthermore, the acquisition unit acquires information regarding positions where the plurality of utterers is located, in a space where the plurality of utterers is located. The recognition unit recognizes the attributes of the plurality of utterers, on the basis of the information regarding the positions where the plurality of utterers is located.

In this way, even in a case where it is difficult to perform recognition using the voice or the movement of the lips, the information processing device can improve the accuracy of specifying the person, by specifying the person on the basis of the position where the person is located.

Furthermore, the acquisition unit acquires the composition information of the voice generated by each of the plurality of utterers. The recognition unit recognizes the attributes of the plurality of utterers, on the basis of the composition information of each of the voices generated by the plurality of utterers.

In this way, the information processing device can improve person recognition accuracy, by recognizing the attribute of the utterer (for example, father, child, or the like) on the basis of the feature amount of the voice.

Furthermore, the recognition unit recognizes whether or not the plurality of utterers requests the generation of the response, on the basis of the acquired voice and video. The generation unit generates different responses, according to whether or not the plurality of utterers requests the generation of the response.

In this way, the information processing device can prevent generation of a response to an irrelevant utterance, by selectively generating the response to the utterance toward the agent.

Furthermore, the recognition unit recognizes whether or not the plurality of utterers requests the generation of the response, on the basis of the line of sight or the direction of the lips of the utterer in the acquired video.

In this way, the information processing device can enhance the recognition accuracy, by recognizing whether or not the utterance is generated toward the agent on the basis of not only the voice but also the line of sight of the utterer or the like.

Furthermore, the recognition unit recognizes whether or not the plurality of utterers requests the generation of the response, on the basis of at least one of the content of the voice generated by the utterer, the directivity of the voice, and the composition information of the voice.

In this way, the information processing device can more accurately determine whether or not the target of the utterance is the agent, by recognizing the utterance on the basis of the feature amount indicating the conversation between persons or the voice generated toward the agent.

Furthermore, the generation unit generates the response to the recognized utterance, on the basis of the priority associated with the attribute of each utterer.

In this way, the information processing device can execute optimal interaction processing in accordance with a situation of the place, for example, preferentially outputting a response to a user who has a decision right from among utterers located in the place, by generating the response according to the priority.

Furthermore, the recognition unit recognizes the emotion of the utterer in the utterance generated by each utterer, as the property of the utterance. The generation unit generates the response to the recognized utterance, on the basis of the priority determined according to the emotion of each utterer.

In this way, the information processing device can return the response coping with an emergency or the like, by generating the response according to the emotion such as the sense of tightness or urgency.

Furthermore, the recognition unit recognizes the emotion of the utterer, on the basis of at least one of the expression of the utterer in the video, the movement of the lips, the composition information of the voice in the utterance.

In this way, the information processing device can return the response according to the emotion of the utterer, by executing generation processing, after recognizing the emotion on the basis of the video of the utterer or the like.

Furthermore, the acquisition unit acquires the information regarding the external environment of the space where the plurality of utterers is located. The generation unit generates the response to the recognized utterance, on the basis of the information regarding the external environment acquired by the acquisition unit.

In this way, the information processing device can generate a natural response that is more suitable to the place, by executing response generation processing including the external environment.

Furthermore, the acquisition unit acquires the information indicating whether or not the predetermined situation defined in advance occurs, as the information regarding the external environment. In a case of determining that the predetermined situation occurs, the generation unit generates the response corresponding to the predetermined situation, in preference to the response to the utterer.

In this way, even in a case where a situation different from a normal situation occurs, by making a response assuming various situations, such as the approach of the emergency vehicle, the information processing device can return the response suitable for the situation.

Furthermore, the acquisition unit acquires the information regarding the time band or the weather, as the information regarding the external environment. The generation unit generates the response corresponding to the time band or the weather.

In this way, the information processing device can generate the response suitable for the situation, by generating the response in consideration of the time band or the weather.

Furthermore, the acquisition unit acquires the video captured by the imaging device installed in the vehicle on which the plurality of utterers rides. The generation unit generates the response regarding the behavior of the vehicle, as the response to the recognized utterance.

In this way, the information processing device generates the response to the plurality of utterers in the vehicle. That is, the information processing device can generate the response suitable for the situation, even in a situation where it is difficult to hear the voice due to noise or it is difficult to recognize the voice because the plurality of utters generates the utterances.

### 4. Hardware Configuration

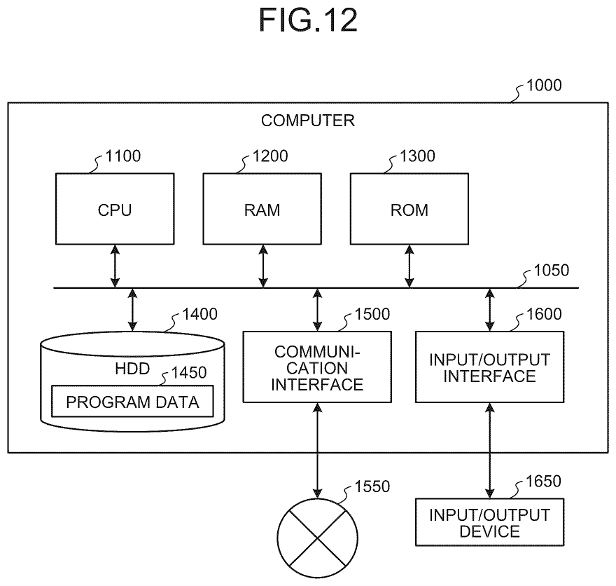

An information device such as the information processing device according to the present disclosure described above is implemented, for example, by a computer 1000 having a configuration illustrated in FIG. 12. FIG. 12 is a hardware configuration diagram illustrating an example of the computer 1000 that implements the functions of the information processing device according to the present disclosure. Hereinafter, as the information processing device according to the present disclosure, the vehicle 100 according to the embodiment will be described as an example. The computer 1000 includes a CPU 1100, a RAM 1200, a read only memory (ROM) 1300, a hard disk drive (HDD) 1400, a communication interface 1500, and an input/output interface 1600. Each unit of the computer 1000 is connected by a bus 1050.

The CPU 1100 operates on the basis of a program stored in the ROM 1300 or the HDD 1400 and controls each unit. For example, the CPU 1100 develops the program stored in the ROM 1300 or the HDD 1400 on the RAM 1200 and executes processing corresponding to various programs.

The ROM 1300 stores a boot program of a basic input output system (BIOS) or the like executed by the CPU 1100 at the time of activation of the computer 1000, a program depending on hardware of the computer 1000, or the like.

The HDD 1400 is a computer-readable recording medium that non-transiently records a program executed by the CPU 1100, data used for the program, or the like. Specifically, the HDD 1400 is a recording medium that records the information processing program according to the present disclosure that is an example of program data 1450.

The communication interface 1500 is an internet used to connect the computer 1000 to an external network 1550 (for example, the Internet). For example, the CPU 1100 receives data from other devices or transmits data generated by the CPU 1100 to the other devices, via the communication interface 1500.

The input/output interface 1600 is an interface used to connect an input/output device 1650 to the computer 1000. For example, the CPU 1100 receives data from an input device such as a keyboard or a mouse, via the input/output interface 1600. Furthermore, the CPU 1100 transmits data to an output device such as a display, a speaker, or a printer, via the input/output interface 1600. Furthermore, the input/output interface 1600 may function as a medium interface that reads a program recorded in a predetermined recording medium (media) or the like. The medium is, for example, an optical recording medium such as a digital versatile disc (DVD) or a phase change rewritable disk (PD), a magneto-optical recording medium such as a magneto-optical disk (MO), a tape medium, a magnetic recording medium, or a semiconductor memory.

For example, in a case where the computer 1000 functions as the vehicle 100 according to the embodiment, the CPU 1100 of the computer 1000 implements the functions of the control unit 130 or the like, by executing the information processing program loaded on the RAM 1200. Furthermore, the HDD 1400 stores the information processing program according to the present disclosure and the data in the storage unit 120. Note that the CPU 1100 reads and executes the program data 1450 from the HDD 1400. However, as another example, these programs may be acquired from another device, via the external network 1550.

Note that the present technology can have the following configurations.

(1)

An information processing device including:
an acquisition unit configured to acquire voices generated by a plurality of utterers and a video in which a state where the utterer generates an utterance is imaged;
a specification unit configured to specify each of the plurality of utterers, on a basis of the acquired voice and video;
a recognition unit configured to recognize an utterance generated by each specified utterer and an attribute of each utterer or a property of the utterance; and
a generation unit configured to generate a response to the recognized utterance, on a basis of the recognized attribute of each utterer or property of the utterance.
   (2)

The information processing device according to (1), in which
the generation unit
determines a priority of the response to the recognized utterance, on a basis of the recognized attribute of each utterer or property of the utterance, and
the information processing device further includes:
an output control unit configured to output the response to the recognized utterance, according to the priority determined by the generation unit.
   (3)

The information processing device according to (1) or (2), in which
the acquisition unit
acquires a video in which lips of the utterer are imaged, as the video, and
the specification unit
specifies each of the plurality of utterers, on a basis of the video in which the lips of the utterer are imaged.
   (4)

The information processing device according to (3), in which
the recognition unit
recognizes each utterance generated by each utterer, on a basis of the voice generated by each utterer or a movement of the lips of each utterer.
   (5)

The information processing device according to any one of (1) to (4), in which
the acquisition unit
acquires the video in which the state where the utterer generates the utterance is imaged, after detecting the utterer by temperature detection.
   (6)

The information processing device according to any one of (1) to (5), in which
the acquisition unit
acquires information regarding positions where the plurality of utterers is located, in a space where the plurality of utterers is located, and
the recognition unit
recognizes attributes of the plurality of utterers, on a basis of the information regarding the positions where the plurality of utterers is located.
   (7)

The information processing device according to any one of (1) to (6), in which
the acquisition unit
acquires composition information of each voice generated by the plurality of utterers, and
the recognition unit
recognizes the attributes of the plurality of utterers, on a basis of the composition information of each voice generated by the plurality of utterers.
   (8)

The information processing device according to any one of (1) to (7), in which
the recognition unit
recognizes whether or not the plurality of utterers requests generation of the response, on a basis of the acquired voice and video, and
the generation unit
generates a response different according to whether or not the plurality of utterers requests the generation of the response.
   (9)

The information processing device according to (8), in which
the recognition unit
recognizes whether or not the plurality of utterers requests the generation of the response, on a basis of a line of sight or a direction of the lips of the utterer in the acquired video.
   (10)

The information processing device according to (8) or (9), in which
the recognition unit
recognizes whether or not the plurality of utterers requests the generation of the response, on a basis of at least one of content of the voice generated by the utterer, directivity of the voice, and the composition information of the voice.
   (11)

The information processing device according to any one of (1) to (10), in which
the generation unit
generates the response to the recognized utterance, on a basis of a priority associated with the attribute of each utterer.
   (12)

The information processing device according to any one of (1) to (11), in which
the recognition unit
recognizes an emotion of the utterer in the utterance generated by each utterer, as the property of the utterance, and
the generation unit
generates the response to the recognized utterance, on a basis of a priority determined according to the emotion of each utterer.
   (13)

The information processing device according to (12), in which
the recognition unit
recognizes the emotion of the utterer, on a basis of at least one of an expression of the utterer in the video, the movement of the lips, and the composition information of the voice in the utterance.
   (14)

The information processing device according to any one of (1) to (13), in which
the acquisition unit
acquires information regarding an external environment of the space where the plurality of utterers is located, and the generation unit
generates the response to the recognized utterance, on a basis of the information regarding the external environment acquired by the acquisition unit.
   (15)

The information processing device according to (14), in which
the acquisition unit
acquires information indicating whether or not a predetermined situation defined in advance occurs, as the information regarding the external environment, and
the generation unit
generates a response corresponding to the predetermined situation, in preference to the response to the utterer, in a case where it is determined that the predetermined situation occurs.
   (16)

The information processing device according to (14) or (15), in which
the acquisition unit
acquires information regarding a time band or a weather, as the information regarding the external environment, and
the generation unit
generates a response corresponding to the time band or the weather.
   (17)

The information processing device according to any one of (1) to (16), in which
the acquisition unit
acquires the video imaged by an imaging device installed in a vehicle on which the plurality of utterers rides, and
the generation unit
generates a response regarding a behavior of the vehicle, as the response to the recognized utterance.
   (18)

An information processing method by a computer, including:
acquiring voices generated by a plurality of utterers and a video in which a state where the utterer generates an utterance is imaged;
specifying each of the plurality of utterers, on a basis of the acquired voice and video;
recognizing an utterance generated by each specified utterer and an attribute of each utterer or a property of the utterance; and
generating a response to the recognized utterance, on a basis of the recognized attribute of each utterer or property of the utterance.
   (19)

An information processing program for causing a computer to function as:
an acquisition unit that acquires voices generated by a plurality of utterers and a video in which a state where the utterer generates an utterance is imaged;
a specification unit that specifies each of the plurality of utterers, on a basis of the acquired voice and video;
a recognition unit that recognizes an utterance generated by each specified utterer and an attribute of each utterer or a property of the utterance; and
a generation unit that generates a response to the recognized utterance, on a basis of the recognized attribute of each utterer or property of the utterance.

### REFERENCE SIGNS LIST

100 VEHICLE
110 COMMUNICATION UNIT
120 STORAGE UNIT
121 USER INFORMATION STORAGE UNIT
122 EXTERNAL STATUS STORAGE UNIT
123 DETERMINATION MODEL STORAGE UNIT
130 CONTROL UNIT
131 ACQUISITION UNIT
132 SPECIFICATION UNIT
133 RECOGNITION UNIT
134 GENERATION UNIT
135 OUTPUT CONTROL UNIT
140 DETECTION UNIT
145 OUTPUT UNIT
146 DISPLAY UNIT
147 VOICE OUTPUT UNIT

1. An information processing device comprising:
an acquisition unit configured to acquire voices generated by a plurality of utterers and a video in which a state where the utterer generates an utterance is imaged;
a specification unit configured to specify each of the plurality of utterers, on a basis of the acquired voice and video;
a recognition unit configured to recognize an utterance generated by each specified utterer and an attribute of each utterer or a property of the utterance; and
a generation unit configured to generate a response to the recognized utterance, on a basis of the recognized attribute of each utterer or property of the utterance.

2. The information processing device according to claim 1, wherein
the generation unit
determines a priority of the response to the recognized utterance, on a basis of the recognized attribute of each utterer or property of the utterance, and
the information processing device further comprising:
an output control unit configured to output the response to the recognized utterance, according to the priority determined by the generation unit.

3. The information processing device according to claim 1, wherein
the acquisition unit
acquires a video in which lips of the utterer are imaged, as the video, and
the specification unit
specifies each of the plurality of utterers, on a basis of the video in which the lips of the utterer are imaged.

4. The information processing device according to according to claim 3, wherein
the recognition unit
recognizes each utterance generated by each utterer, on a basis of the voice generated by each utterer or a movement of the lips of each utterer.

5. The information processing device according to claim 1, wherein
the acquisition unit
acquires the video in which the state where the utterer generates the utterance is imaged, after detecting the utterer by temperature detection.

6. The information processing device according to claim 1, wherein
the acquisition unit
acquires information regarding positions where the plurality of utterers is located, in a space where the plurality of utterers is located, and
the recognition unit
recognizes attributes of the plurality of utterers, on a basis of the information regarding the positions where the plurality of utterers is located.

7. The information processing device according to claim 1, wherein
the acquisition unit
acquires composition information of each voice generated by the plurality of utterers, and
the recognition unit
recognizes the attributes of the plurality of utterers, on a basis of the composition information of each voice generated by the plurality of utterers.

8. The information processing device according to claim 1, wherein
the recognition unit
recognizes whether or not the plurality of utterers requests generation of the response, on a basis of the acquired voice and video, and
the generation unit
generates a response different according to whether or not the plurality of utterers requests the generation of the response.

9. The information processing device according to claim 8, wherein
the recognition unit
recognizes whether or not the plurality of utterers requests the generation of the response, on a basis of a line of sight or a direction of lips of the utterer in the acquired video.

10. The information processing device according to claim 8, wherein
the recognition unit
recognizes whether or not the plurality of utterers requests the generation of the response, on a basis of at least one of content of the voice generated by the utterer, directivity of the voice, and the composition information of the voice.

11. The information processing device according to claim 1, wherein
the generation unit
generates the response to the recognized utterance, on a basis of a priority associated with the attribute of each utterer.

12. The information processing device according to claim 1, wherein
the recognition unit
recognizes an emotion of the utterer in the utterance generated by each utterer, as the property of the utterance, and
the generation unit
generates the response to the recognized utterance, on a basis of a priority determined according to the emotion of each utterer.

13. The information processing device according to claim 12, wherein
the recognition unit
recognizes the emotion of the utterer, on a basis of at least one of an expression of the utterer in the video, a movement of lips, and composition information of the voice in the utterance.

14. The information processing device according to claim 1, wherein
the acquisition unit
acquires information regarding an external environment of a space where the plurality of utterers is located, and
the generation unit
generates the response to the recognized utterance, on a basis of the information regarding the external environment acquired by the acquisition unit.

15. The information processing device according to claim 14, wherein
the acquisition unit
acquires information indicating whether or not a predetermined situation defined in advance occurs, as the information regarding the external environment, and
the generation unit
generates a response corresponding to the predetermined situation, in preference to the response to the utterer, in a case where it is determined that the predetermined situation occurs.

16. The information processing device according to claim 14, wherein
the acquisition unit
acquires information regarding a time band or a weather, as the information regarding the external environment, and
the generation unit
generates a response corresponding to the time band or the weather.

17. The information processing device according to claim 1, wherein
the acquisition unit
acquires the video imaged by an imaging device installed in a vehicle on which the plurality of utterers rides, and
the generation unit
generates a response regarding a behavior of the vehicle, as the response to the recognized utterance.

18. An information processing method by a computer, comprising:
acquiring voices generated by a plurality of utterers and a video in which a state where the utterer generates an utterance is imaged;
specifying each of the plurality of utterers, on a basis of the acquired voice and video;
recognizing an utterance generated by each specified utterer and an attribute of each utterer or a property of the utterance; and
generating a response to the recognized utterance, on a basis of the recognized attribute of each utterer or property of the utterance.

19. An information processing program for causing a computer to function as:
an acquisition unit that acquires voices generated by a plurality of utterers and a video in which a state where the utterer generates an utterance is imaged;
a specification unit that specifies each of the plurality of utterers, on a basis of the acquired voice and video;
a recognition unit that recognizes an utterance generated by each specified utterer and an attribute of each utterer or a property of the utterance; and
a generation unit that generates a response to the recognized utterance, on a basis of the recognized attribute of each utterer or property of the utterance.
